(19) United States
(12) Patent Application Publication
(10) Pub. No.: US 2009/0054069 A1
(43) Pub. Date: Feb. 26, 2009

(54) Platform Independent Communication Protocol

(75) Inventors: Paul William Calnan, III, Somerville, MA (US); Michael Vosseller, Somerville, MA (US); Lorraine Wheeler, Billerica, MA (US)

Correspondence Address: FISH & RICHARDSON, PC, P.O. BOX 1022, MINNEAPOLIS, MN, 55440-1022, US

(73) Assignee: Zeetoo, Inc.

(21) Appl. No.: 11/844,999

(22) Filed: Aug. 24, 2007

(51) Int. Cl. H04Q 7/22

(52) U.S. Cl. 455/445

(57) ABSTRACT

Among other things, techniques for enabling platform independent bidirectional communications between a mobile controller device and a host device over a communication protocol is disclosed. Enabling the communications includes delivering an array of bytes from the mobile controller device to the host device. The array of bytes describes one or more data packets of the mobile controller device. When detected that the host device includes a native device driver, the native device driver is used to parse the delivered array of bytes. Alternatively, when detected that the host device does not include a native device driver, a device driver is provided to parse the delivered array of bytes.

### TECHNICAL FIELD

This disclosure is directed to techniques for enabling platform independent bidirectional communications between a mobile controller device and a host device over a communication protocol.

### BACKGROUND

Mobile devices, such as a mobile phone may no longer be seen as simply a communications device providing voice call functionality. Mobile devices may be implemented as a computing platform that can be used to run a variety of applications, including text messaging, address book, calendar, other productivity applications, mapping applications, gaming applications and many others.

The Bluetooth 2.0 standard can specify a variety of “profiles” designed to enable a limited number of devices, such as a mouse, a keyboard, a wireless headset, and a hands free car kit to communicate with the mobile phone. These profiles are typically implemented in firmware on mobile phones—for example, a mobile phone that supports the Human Interface Device (“HID”) profile would have the HID protocol embedded in firmware. In addition, to take advantage of a Bluetooth 2.0 profile, both the mobile phone and the input, output, or input/output device that the mobile phone wishes to communicate with are required to have the same profile supported in firmware or software.

### SUMMARY

Implementations of the human interface and input system and techniques for enabling platform independent communications between a mobile controller device and a host device described here may include various combinations of the following features.

In one aspect, providing platform independent bidirectional communications between a mobile controller device and a host device over a communication protocol includes delivering an array of bytes from the mobile controller device to the host device. The array of bytes delivered describes one or more data packets of the mobile controller device. When detected that the host device includes a native device driver, the native device driver is used to parse the delivered array of bytes. Alternatively, when detected that the host device does not include a native device driver, a device driver is provided to parse the delivered array of bytes.

Implementations may optionally include one or more of the following features. Providing the device driver can include providing a customized human interface device driver based on the delivered array of bytes. Also, to provide the platform independent bidirectional communications, bidirectional communications compatible with Java platform can be provided. To deliver the array of bytes, a fixed number of bytes from the array of bytes can be used to generate one or more device specific descriptors that support one or more sensors not supported by a native human interface device descriptor. Further, generating the one or more device specific descriptors that support one or more sensors can include generating one or more device specific descriptors that support at least one selected from a group of a joystick, a linear potentiometer, a trackball, an encoder, a force sensitive resistor, a strain gauge, a series of digital switches, an accelerometer, a gyro, an inertial sensor, and an electromagnetic sensor. Also, providing the platform independent bidirectional communications can include providing at least two communication channels that are accessible by a Java platform driver. In addition, delivering the array of bytes can include delivering a variable sequence of bytes customized for the mobile controller device. Delivering a variable sequence of bytes can further include mapping each byte in the sequence of bytes to one or more input elements on the mobile controller device; and changing a value assigned to each byte based on a state of the input element.

In another aspect, the techniques described in this specification can be implemented as a computer program product, embodied on a computer-readable medium and designed to cause a data processing apparatus to perform various operations. For example, the computer program product is designed to provide platform independent bidirectional communications between a mobile controller device and a host device over a communication protocol. Providing the platform independent bidirectional communication includes delivering an array of bytes from the mobile controller device to the host device, with the array of bytes describing one or more data packets of the mobile controller device. When detected that the host device includes a native device driver, the computer program product is designed to use the native device driver to parse the delivered array of bytes. Alternatively, when detected that the host device does not include a native device driver, the computer program product is designed to provide a device driver to parse the delivered array of bytes.

Implementations can optionally include one or more of the following features. The computer program product can be designed to cause the data processing apparatus to perform operations further comprising providing a customized human interface device driver based on the delivered array of bytes. The computer program product can be designed to cause the data processing apparatus to perform operations that includes providing platform independent bidirectional communications by at least providing bidirectional communications compatible with Java platform. The computer program product can be designed to cause the data processing apparatus to perform operations that includes delivering an array of bytes by at least using a fixed number of bytes from the array of bytes to generate one or more device specific descriptors that support one or more sensors not supported by a native human interface device descriptor. Also, the computer program product can be designed to cause the data processing apparatus to perform operations that includes generating one or more device specific descriptors that support one or more sensors by at least generating one or more device specific descriptors that support at least one selected from a group of a joystick, a linear potentiometer, a trackball, an encoder, a force sensitive resistor, a strain gauge, a series of digital switches, an accelerometer, a gyro, an inertial sensor, and an electromagnetic sensor. The computer program product can be designed to cause the data processing apparatus to perform operations that includes providing platform independent bidirectional communication having at least two communication channels that are accessible by a Java platform driver. The computer program product can be designed to cause the data processing apparatus to perform operations that includes delivering an array of bytes having a variable sequence of bytes customized for the mobile controller device. Further, the computer program product can be designed to cause the data processing apparatus to perform operations that includes delivering a variable sequence of bytes that includes mapping each byte in the sequence of bytes to one or more input elements on the mobile controller device; and changing a value assigned to each byte based on a state of the input element.

In yet another aspect, the techniques described in this specification can be implemented as a mobile controller device that includes a communication mechanism designed to operate a communication stack including a baseband protocol designed to connect the mobile controller device to a host device. The mobile controller device also includes a bidirectional serial communication protocol designed to operate over the baseband protocol to send one or more messages to the host device. Each sent message includes a sequence of bytes. The controller device also includes a controller firmware designed to monitor input signals provided by various input mechanisms available to the mobile controller device, and generate the one or more messages. The bidirectional serial communication protocol enables platform independent bidirectional communications between the mobile controller device and a host device over the baseband protocol.

Implementations can optionally include one or more of the following features. The bidirectional serial communication protocol that enables platform independent bidirectional communications can include a bidirectional communication compatible with Java platform. The controller firmware can be designed to take a fixed number of bytes from the sequence of bytes to generate one or more device specific descriptors that support one or more sensors not supported by a native human interface device descriptor. The controller firmware can also be designed to generate one or more device specific descriptors that support at least one selected from a group of a joystick, a linear potentiometer, a trackball, an encoder, a force sensitive resistor, a strain gauge, a series of digital switches, an accelerometer, a gyro, an inertial sensor, and an electromagnetic sensor. The controller firmware can be designed to generate the one or more messages, with each generated message including a variable sequence of bytes customized for the mobile controller device. The controller firmware can be designed to map each byte in the sequence of bytes to one or more input elements of the various input mechanisms available to the mobile controller device and change a value assigned to each byte based on a state of the mapped one or more input elements.

Techniques for enabling platform independent bidirectional communications between a mobile controller device and a host device over a communication protocol described herein potentially may provide one or more of the following advantages. The systems and techniques described in this specification may provide an efficient, lightweight mechanism for a mobile controller device and a host device to exchange sensor data, state information and any other types of data that can be serialized and sent in a small footprint. The mechanism can be fast and efficient, take up a small footprint in firmware and/or software, and incur a minimum amount of timing overhead in the process of sending and receiving the pertinent data. The mechanism can be specifically defined to support a wide variety of sensors commonly used in gaming, including analog signals from potentiometers or multiple-degrees-of-freedom analog joysticks; digital encoders such as what might be found in optical mice, or in higher end robotic devices; force sensitive resistors which provide a proportional signal in response to varying pressures applied; accelerometer and gyroscope signals; signals from trackballs; signals from force sensing devices such as strain gauge based navigation sticks; proportional or digital signals from optical sensors, signals from electromagnetic sensors and the like. The mechanism can be implemented as a communication protocol that can also be extended to enable the mobile controller device and the host device to exchange other types of data that can be serialized, such as game state information, car diagnostic information, GPS fixes and the like.

The systems, and techniques described in this specification may be implemented as an Application Program Interface (API) that can operate across a variety of transport protocols, such as the Bluetooth logical link control and adaptation protocol (L2CAP) or the Bluetooth serial port profile (SPP), or over other wired or wireless transport protocols. For example, the same API can be designed to support communications over USB, Firewire, IrDA or other wired and wireless communication protocols.

The communication protocol can furthermore be implemented in a variety of mechanisms, including an HID based mechanism, a fixed-length serial mechanism involving a fixed number of bytes with a predefined syntax that is sent from the mobile controller device to the host device, and a bidirectional communication protocol mechanism allowing queries and data to be sent from the mobile controller device to the host device and vise versa.

The HID based mechanism can provide a lightweight Java implementation of a subset of the HID profile on the host device, and optionally include custom HID descriptors to support common sensors appropriate for mobile controller devices. The fixed-length serial mechanism can reflect a byte structure with a fixed number of bytes that is largely universal to sensors appropriate for mobile controller devices. The bidirectional serial communication protocol mechanism can involve a custom byte sequence structure can be implemented to provide support for common sensors appropriate for mobile controller devices

Regardless of whether the HID based mechanism or a serial communication protocol is implemented, the systems and techniques described in this specification may furthermore be incorporated in an API implemented on a programming platform running on the host device, such as Java. Such API can be incorporated into applications running on the host device.

The subject matter described in this specification can be implemented as a method, a system or computer program products tangibly embodied in information carriers, such as a CD-ROM, a DVD-ROM, a semiconductor memory, or a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various data processing machines.

Details of one or more implementations are set forth in the accompanying drawings and the description below. Other features and advantages will be apparent from the description and drawings, and from the claims.

### DESCRIPTION OF DRAWINGS

FIGS. 1a and 1b are block diagrams illustrating a system for enabling communications between a controller device and a host device.

FIG. 2 illustrates an exemplary report descriptor 300 designed for an HID joystick device for an HID based mechanism.

FIGS. 3, 4 and 5 illustrate exemplary custom report descriptors designed to enable communications for a variety of sensors for an HID based mechanism.

FIG. 6 is a block diagram illustrating an implementation of an HID based mechanism, describing a system for enabling communications between a HID class device and an HID enabled host device.

FIG. 7 is a block diagram illustrating a Bluetooth stack for an implementation of a fixed-length serial approach that enables communications using a fixed-length byte sequence.

FIG. 8 illustrates an exemplary byte sequence for a four-byte sequence with a termination byte.

FIG. 9 illustrates an exemplary byte sequence for a five-byte sequence with a termination byte.

FIG. 10 illustrates an exemplary communication stack for implementing a bidirectional serial communication protocol based mechanism over implemented over Bluetooth Serial Port Profile (SPP).

FIG. 11 illustrates an exemplary byte sequence, or report format, for a bidirectional serial communication protocol mechanism.

FIG. 12 illustrates an exemplary message format for SET_IDLE.

FIG. 13 describes an exemplary byte sequence showing an idle rate.

FIG. 14 illustrates an exemplary byte sequence for a Version Report.

FIG. 15 illustrates an exemplary byte sequence for a Configuration Data Input Report.

FIG. 16 illustrates an exemplary byte sequence for a Button Metadata Report.

FIG. 17 illustrates an exemplary byte sequence for an Enable/Disable Report Type.

FIG. 18 illustrates an exemplary byte sequence for a Button Report.

FIG. 19 illustrates an exemplary byte sequence for an 8-bit Analog 2-Axis Joystick Report.

FIG. 20 illustrates an exemplary 16-bit Analog 2-Axis Joystick Report.

FIG. 21 illustrates an exemplary 32-bit Analog 2-Axis Joystick Report.

FIG. 22 illustrates an exemplary 8-bit Analog 3-Axis Accelerometer Report.

FIG. 23 illustrates an exemplary 16-bit Analog 3-Axis Accelerometer Report.

FIG. 24 illustrates an exemplary 32-bit Analog 3-Axis Accelerometer Report.

FIG. 25 illustrates an exemplary 8-bit Analog Paddle Report.

FIG. 26 illustrates an exemplary 16-bit Analog Paddle Report.

FIG. 27 illustrates an exemplary 32-bit Analog Paddle Report.

FIG. 28 illustrates an exemplary 16-bit Battery Level Report.

FIG. 29 illustrates an exemplary 8-bit Trackball Report.

FIG. 30 illustrates an exemplary 16-bit Trackball Report.

FIG. 31 illustrates an exemplary 32-bit Trackball Report.

FIG. 32 illustrates an exemplary 8-bit Scroll Wheel Report.

FIG. 33 illustrates an exemplary 16-bit Scroll Wheel Report.

FIG. 34 illustrates an exemplary 32-bit Scroll Wheel Report.

FIG. 35 illustrates an exemplary byte sequence for a Raw and Conditioned 8-bit Analog 2-Axis Joystick Report.

FIG. 36 illustrates an exemplary byte sequence for a Run Loop Test Report.

FIG. 37 illustrates an exemplary byte sequence for a 32-bit Device Timestamp (in Milliseconds) report.

FIG. 38 is a process flow diagram illustrating process for enabling communications between a mobile controller device and a host device.

FIG. 39 illustrates an exemplary system for implementing a Java enabled remote controller device that controls mapping application on a navigation system.

FIG. 40 illustrates an exemplary system for providing data exchange between GPS enabled devices.

FIG. 41 illustrates an exemplary system for enabling data communications among a mobile phone, a car and a PC.

FIG. 42 illustrates an exemplary system for enabling data communications among multiple health and fitness devices.

FIG. 43 illustrates an exemplary system for enabling data communications between a Java-enabled joystick controller and a mobile phone.

FIG. 44 illustrates an exemplary system for enabling HID communications in a multi-player mobile gaming scenario.

Like reference symbols in the various drawings indicate like elements.

### DETAILED DESCRIPTION

Overview

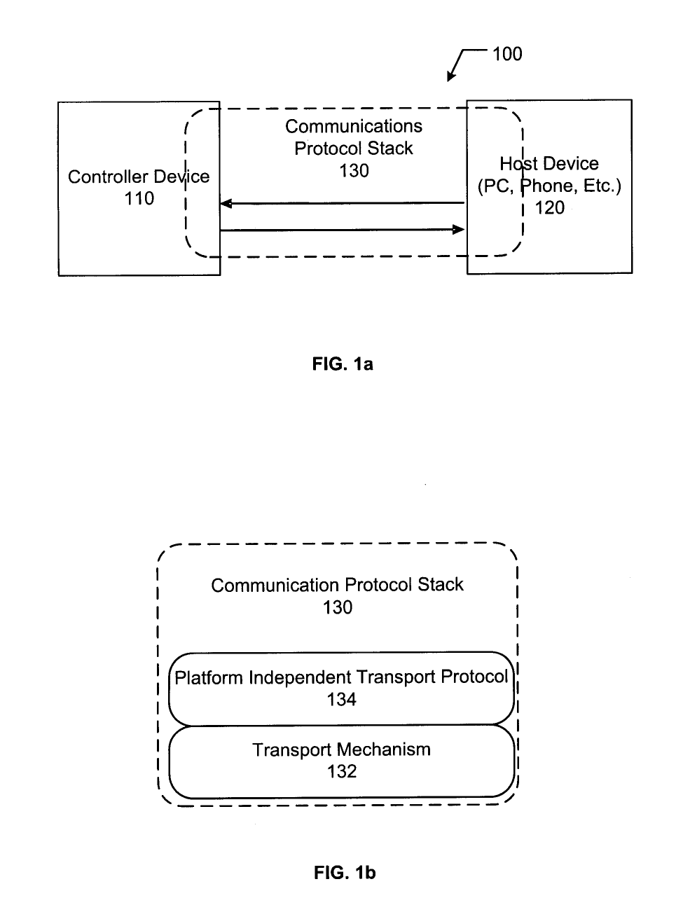

FIGS. 1a and 1b are block diagrams illustrating a system 100 for enabling platform independent (i.e., independent of communication protocol, such as Bluetooth, USB, Firewire, IrDA, etc.) communications between a controller device 110 and a host device 120. The controller device 110 communicates with the host device 120 using a communications protocol 130.

The host device 120 includes devices with one or more embedded processors such as a mobile phone, a personal digital assistant (PDA), a smart phone, a personal navigation systems, a digital video recorder (DVR) device, a car with technology upgrades that provides information (e.g., GPS navigation, wireless communication) and/or entertainment (e.g., digital video disk drive), a pedometer, a glucose meter, a blood pressure sensor, a bathroom scale and the like. The input controller device 110 is designed to communicate with the host device 120 and provide intuitive interface elements for controlling the host device 120. By providing intuitive interface elements, the controller device 110 can facilitate control and execution of complex applications such as gaming and mapping applications, for example. The controller device 110 includes mobile accessory devices that provide various intuitive control interface elements. Examples of such controller devices 110 are described in co-pending U.S. patent application entitled “Human Interface Input Acceleration System” (U.S. Patent Application Publication No. 20070080934) and U.S. patent application entitled “Human Interface Input Acceleration System” (U.S. Patent Application Publication No. 20070080931.) The contents of these co-pending applications (U.S. Patent Application Publication Nos. 20070080934 and 20070080931) are incorporated by reference.

The communications protocol stack 130 enables bidirectional exchange of communication signals between the controller device 110 and the host device 120. The communications protocol stack 130 includes a platform independent transport protocol 134 operating on top of a transport mechanism 132. The transport mechanism 132 includes one or more wired or wireless transport/communications protocols such as Bluetooth, Universal Serial Bus (USB), Firewire, IrDA, etc. The platform independent transport protocol 134 is designed to operate over one or more of the various transport mechanisms. The platform independent transport protocol 134 can be implemented using an application programming interface (API) that resides on top of the transport mechanism 132. An API is a source code interface that a computer system or program library provides to support requests for services.

The platform independent transport protocol 134 as described in this specification can be implemented under various mechanisms to enable communications between a mobile controller device and a host device or among multiple mobile controller devices and host devices. For example, the platform independent transport protocol can be implemented under an HID based mechanism, a fixed-length serial mechanism, or a bidirectional serial communication protocol mechanism.

HID Based Mechanism

The platform independent transport protocol 134 can be implemented under an HID based mechanism to enable communications between a mobile controller device and a host device. The HID based communication protocol is built upon the existing HID specifications for standard HID devices. (see, e.g., Universal Serial Bus (USB) Device Class Definition for Human Interface Devices (HID), Version 1.11 (www.usb.org) and the Universal Serial Bus (USB) HID Usage Tables, Version 1.12 (www.usb.org), which are incorporated in full herein by reference.). A lightweight Java 2 Micro Edition (J2ME) implementation for a HID profile can be implemented to run on mobile devices such as mobile phones and other mobile device that serve as a host device. The firmware on one or more mobile controller devices also contain a lightweight implementation of the HID profile. Custom descriptors can be implemented to support common and specialty sensors appropriate for use in the one or more mobile controller devices.

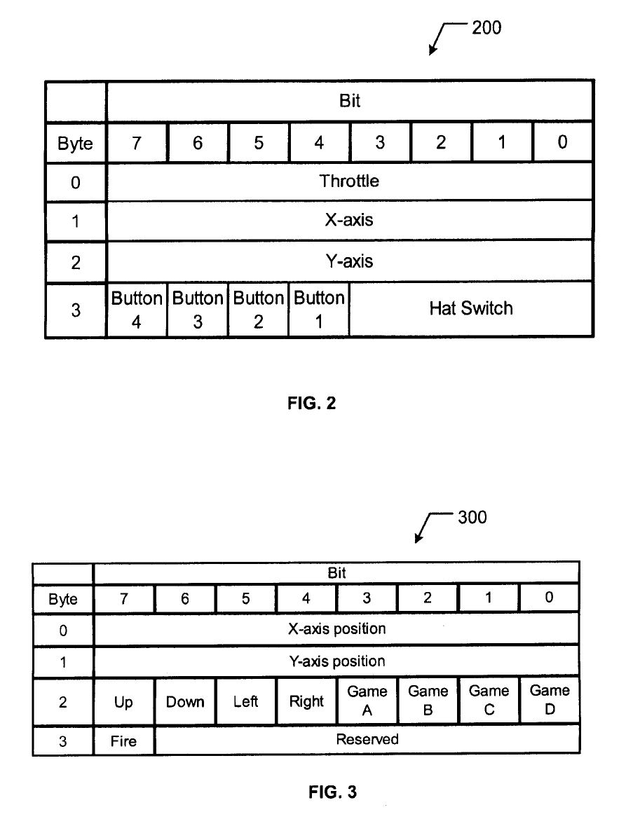

FIG. 2 illustrates an exemplary report descriptor 200 designed for an HID joystick device. The exemplary report descriptor 200 includes the following features: (1) a two-axis joystick that tilts forward/backward and right/left (bytes 1 and 2); (2) an analog throttle control on the base (byte 0); (3) a four position hat switch on the stick (bits 0-3 of byte 3); (4) Two buttons on the stick (bits 4-5 or 6-7 of byte 3); and (5) two buttons on the base (bits 4-5 or 6-7 of byte 3). This descriptor report provides 8-bit resolution for the readings of each joystick.

In addition to the byte layout of a report, a report descriptor can also include some semantics to the various fields. For example, the X-axis field for the joystick can be defined to be an 8 bit signed value that ranges from −127 to 127, representing the position of the joystick along the X-axis. In some implementations, a second descriptor can be provided in which the X- and Y-axis readings provide 16-bit resolution instead of the 8-bit resolution in the first descriptor.

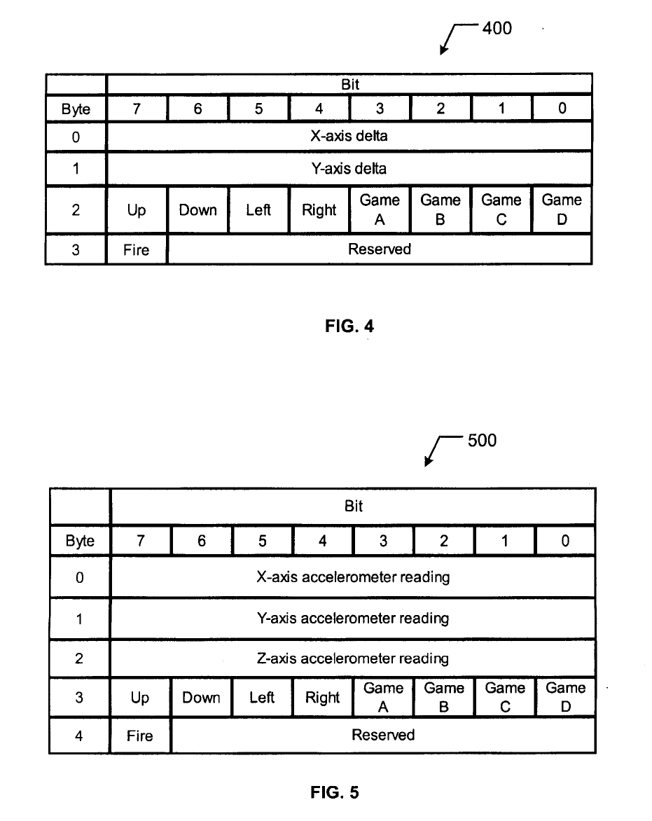

FIGS. 3, 4 and 5 illustrate exemplary custom report descriptors designed to enable communications for a variety of sensors. A fixed number of bytes with unique IDs are selected, and the contents of those selected bytes are applied in different ways, depending on the type of sensor used. This results in a lightweight yet flexible protocol to support a variety of sensors including, e.g., (1) low resolution joysticks with 2 degrees of freedom (DOF) or 3 DOF. (FIG. 3); (2) linear potentiometers; (3) trackballs with 2 (DOF) (encoder like) (FIG. 4); (3) encoders; (4) force sensitive resistors; (5) strain gauges; (6) photosensors; (7) a series of digital switches; (8) accelerometers (FIG. 5); (9) gyros; (10) other inertial sensors; and (11) electromagnetic sensors.

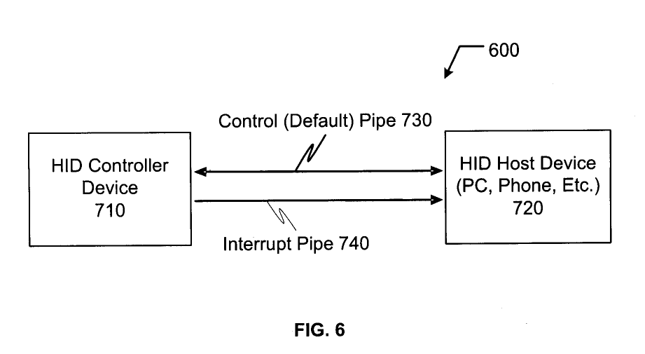

FIG. 6 is a block diagram illustrating a system 600 for enabling communications between a HID class device 610 and an HID host device 620. An HID class device (e.g., controller device 610) communicates with the HID class driver (not shown) on the host device 620 using either a control (default) pipe 630 or an interrupt pipe 640. The control pipe 630 is used to perform operations including (1) receiving and responding to requests for control and class data; (2) transmitting data from the controller device 610 to the host device 620 when polled by the HID class driver from the host device 620; and (3) enabling the controller device 620 to receive data from the host device 620. The interrupt pipe 640 is used to perform operations including (1) receiving asynchronous (unrequested) data from the controller device 610; and (2) transmitting low latency data from the host device 620 to the controller device 610.

These two pipes are implemented in the HID protocol as two L2CAP connections on channels 0x11 and 0x13. To provide support for Java (e.g., J2ME) implementations as a gaming and application development platform, a lightweight Java implementation of a subset of the HID profile is provided Thus, in addition to the two L2CAP channels 0x11 and 0x13 for HIDP compliance , two additional L2CAP channels 0x1011 and 0x1013 are implemented to provide access from a Java driver (e.g., J2ME implementation.)

In an alternative implementation, a custom serial transport protocol is implemented to operate over the Serial Port Profile (SPP). Instead of using an L2CAP implementation as in the HID protocol, other transport mechanisms are employed to provide a transport channel over the Bluetooth stack. The SPP allows various devices to set up an emulated serial cable connection using Radio Frequency Communication (RFCOMM) (See, Serial Port Profile Specification, Version 1.1 (www.bluetooth.org), which is incorporated in full herein by reference.) RFCOMM is a simple transport protocol that provides emulation of the nine circuits of RS-232 serial ports over the L2CAP protocol (See, RFCOMM Specification, Version 1.1 (www.bluetooth.org), which is incorporated in full herein by reference.) This implementation is different from the HID protocol, which uses L2CAP directly and does not use the additional functionality afforded by SPP.

Fixed-Length Serial Protocol Based Mechanism

In an alternative embodiment, a fixed length serial sequence may be employed to allow the mobile controller device to pass information to the host device. This byte sequence may be sent from the mobile controller device to the host device using the Bluetooth SPP (Serial Port Profile) as a transport mechanism.

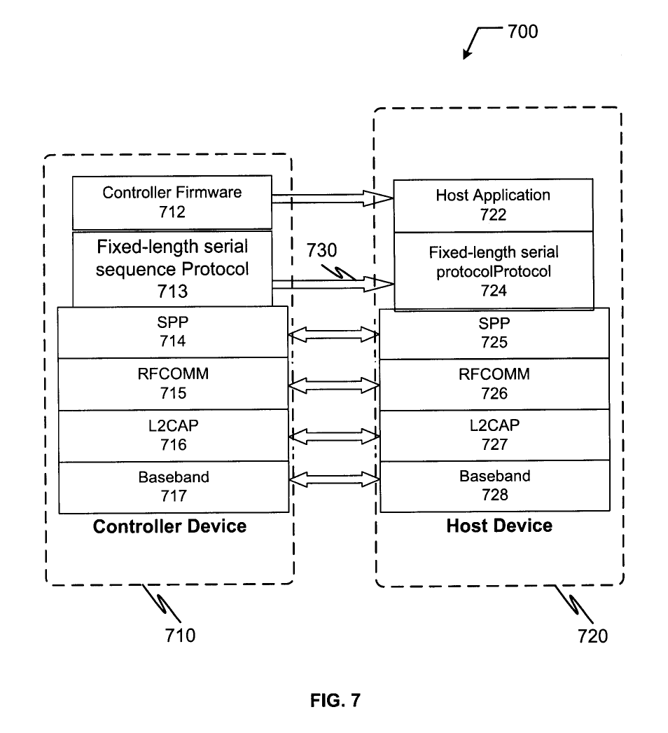

FIG. 7 is a block diagram illustrating a fixed-length serial sequence communication protocol 713, 724, implemented atop the Bluetooth Serial Port Profile, or SPP 714, 725. The protocol stack 700 enables communications using a fixed-length serial communication protocol. The protocol stack 700 includes various protocol modules that can be implemented as layers in a stack of protocols. On the controller device side 710, the layers of the transport protocol stack include a baseband layer 717, a logical link control and adaptation protocol (L2CAP) layer 716, an RFCOMM layer 715, an SPP layer 714, a fixed-byte serial sequence protocol layer 713 and a controller firmware layer 712. On the host device side 720, the layers of the protocol stack include a baseband layer 728, an L2CAP layer 727, an RFCOMM layer 726, a SPP layer 725, a fixed-length serial sequence protocol layer 724 and an application layer 722.

The controller firmware 712 monitors the analog and digital signals provided by the various input mechanisms available to the controller device 710 (e.g., buttons, joysticks, trackballs). Whenever a signal event occurs (e.g., a button is pressed, a joystick is moved), the controller firmware generates a message using the fixed-length protocol 713 and sends the message to the host device 720.

The fixed length byte sequence would have a predetermined number of bytes. Each byte within this sequence would have a specific purpose. In one embodiment, the last byte in the sequence may be designated as the “termination byte” and may always represent a fixed value—for example, 0xFF—that the data is constrained not to reach. In an alternative embodiment, the first byte in the sequence may encode the number of bytes in the byte stream.

The controller driver 723, running on the host device 720 and linked to the host application, receives the fixed-length serial sequence protocol message and translates the message into one or more application-level events. These events are then sent to the host application.

In one implementation, the fixed-length serial sequence protocol 713 is unidirectional 730 from the controller device 710 to the host device 720. While the controller device 710 can send messages to the host device 720, the host device cannot send messages back to the controller device 730. In alternative implementations, the fixed-length protocol 713 may be bidirectional (not shown), enabling the host device to send commands to the mobile controller device using a similarly predetermined, fixed-byte sequence.

The fixed-length serial sequence protocol 713 is an exemplary protocol that can implement a custom, fixed byte sequence to support a wide variety of sensors commonly used in gaming, including (1) analog signals from potentiometers or multiple-degrees-of-freedom analog joysticks; (2) digital encoders such as those found in an optical mouse or in higher end robotic devices; (3) force sensitive resistors that provide a proportional signal in response to varying pressures applied; (4) accelerometer and gyroscope signals; (5) signals from trackballs; (6) signals from force sensing devices such as strain gauge based navigation sticks; (7) proportional or digital signals from optical sensors; (8) signals from electromagnetic sensors; and the like.

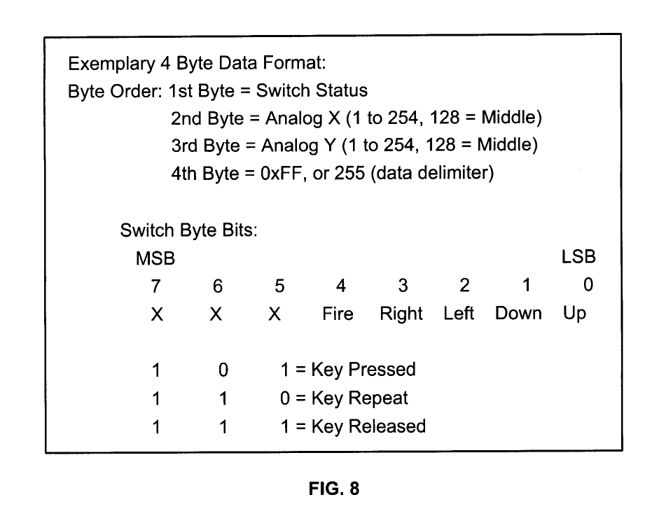

FIG. 8 shows an exemplary byte sequence for a four-byte sequence with a termination byte (0xFF as the 4^{th} byte, or termination byte). In this implementation, the first byte is used as a bitmap to represent the state of buttons pressed. The controller device 710 generates an event when a button press is detected and a different event when a button release is detected. The fixed-length serial sequence protocol also enables the controller device 710 to generate “repeat” events at a fixed period after a button has been pressed and before the button is released. These repeat events are sent periodically (e.g., every 50 ms.) For example, the sequence of events for a single button press can be represented as:
(1) Press Event
(2) Repeat Event
(3) Repeat Events—continue to be sent every 50 ms
(4) Release Event

In one embodiment, the frequency of the repeat events is fixed in the controller's firmware. The frequency is not configurable by the client application. In another embodiment, the frequency of the repeat events may be specified by the host using a fixed-byte serial sequence from the host device to the mobile controller device.

The second and third bytes represent the X and Y values of a joystick, a trackball, an accelerometer or other input elements, each represented as an 8 bit unsigned number (truncated to range from 1 to 254). The last byte is the termination byte, represented by 0xFF. Since the data values are constrained never to reach 255, (which is 0xFF in hexadecimal notation), we ensure that the framing byte value of 0xFF will reliably signify the end of a data stream.

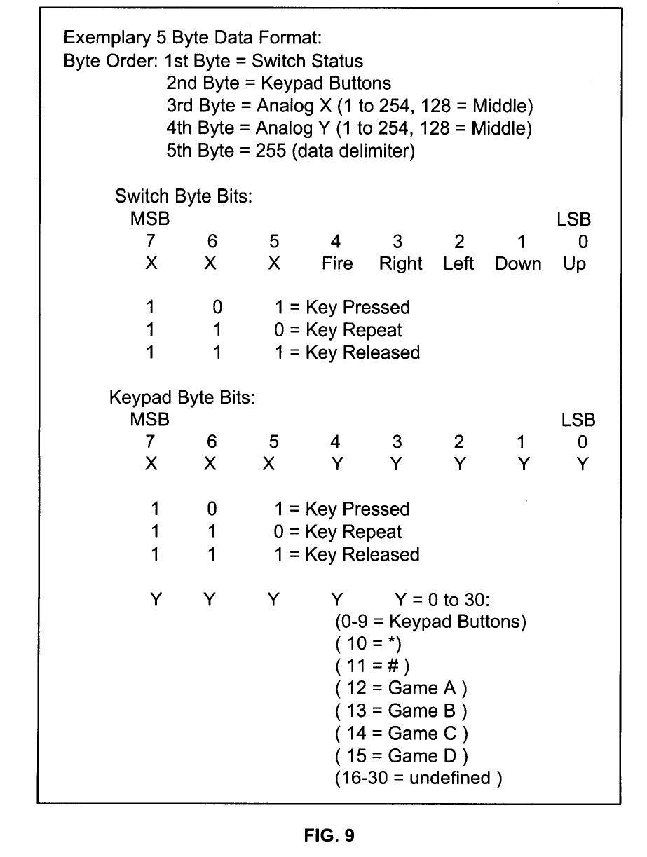

FIG. 9 shows an exemplary byte sequence for a five-byte sequence with a termination byte (0xFF or 255 as the 5^{th} byte, or termination byte). In this example, the first two bytes depict button and keypad events. The third and fourth bytes of the fixed-length serial sequence protocol contain the X and Y values. Each of these values are represented as an unsigned 8 bit value, truncated so that the data values always range from 1 to 254. The fifth byte is a framing byte used to aid legacy versions of the firmware and driver to detect the end of a 5-byte packet. The framing byte is assigned a fixed value which is outside the allowable range of the actual data (e.g., 0xFF or 255.) Since the data values are constrained never to reach 255, (which is 0xFF in hexadecimal notation), we ensure that the framing byte value of 0xFF will reliably signify the end of a data stream.

Bidirection Serial Communication Protocol Based Mechanism

The platform independent communication protocol 134 can be implemented as a bidirectional serial communication protocol operating over a transport mechanism such as the Bluetooth Serial Port Profile (SPP). The byte sequence can be variable in length and flexible and extensible in design. While the Bluetooth Special Interest Group has specified a Human Interface Device Profile (HIDP), the Java 2 Micro Edition (J2ME) implementation of Bluetooth (JSR-82) does not necessarily support HIDP. J2ME also does not necessarily support the two simultaneous L2CAP connections required by HIDP. Thus, the bidirectional serial communication protocol, as described in this specification, is designed to mimic HIDP and to provide an HIDP-like data to flow over an SPP connection (or other connections, such as L2CAP) while supporting J2ME.

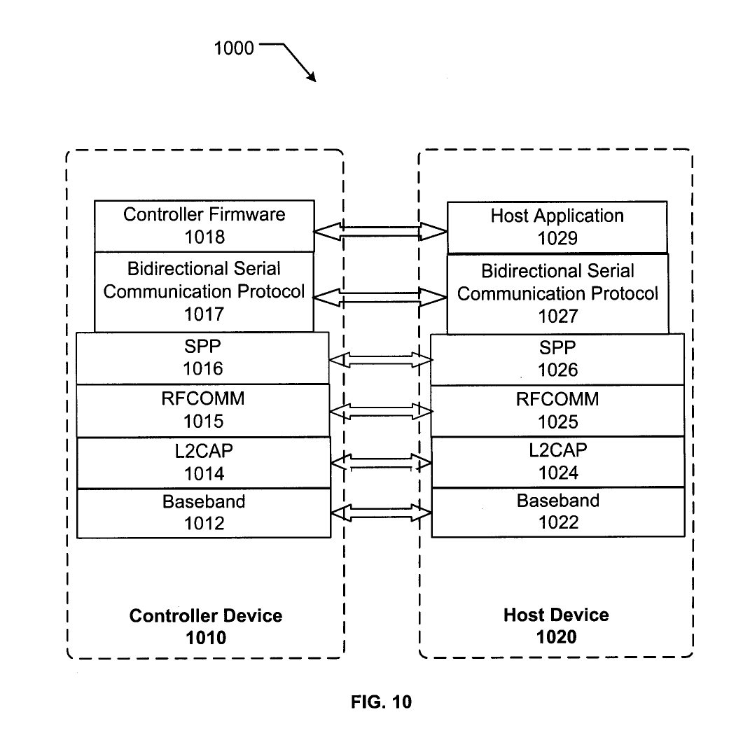

FIG. 10 illustrates an exemplary communication stack 1000 for implementing a bidirectional serial communication protocol based mechanism over the Bluetooth Serial Port Profile, or SPP. The communication stack 1000 provides bidirectional communications between the controller device 1010 and the host device 1020 using a mechanism modeled upon the one used in the HID profile. The controller device 1010 side includes a baseband layer 1012 (e.g., Bluetooth), an L2CAP layer 1014, an RFCOMM layer 1015, an SPP layer 1016, a bidirectional serial communication protocol layer 1017, and a controller firmware 1018. The host device 1020 side includes a baseband layer, 1022, an L2CAP layer 1024, an RFCOMM layer 1025, an SPP layer 1026, a bidirectional serial communication protocol layer 1027, and a host application layer 1029.

In some implementations of the bidirectional serial communication protocol 900, 1100, a fixed number of pre-defined byte sequences, or report formats, are implemented to allow the host device 1020 and mobile controller device 1010 to exchange a variety of data, including sensor information, state information and other types of data. The structure of the byte sequence is designed to be fully extensible so that a set of standard sensor types can be supported initially, and more sensor types can be supported over time as they become developed.

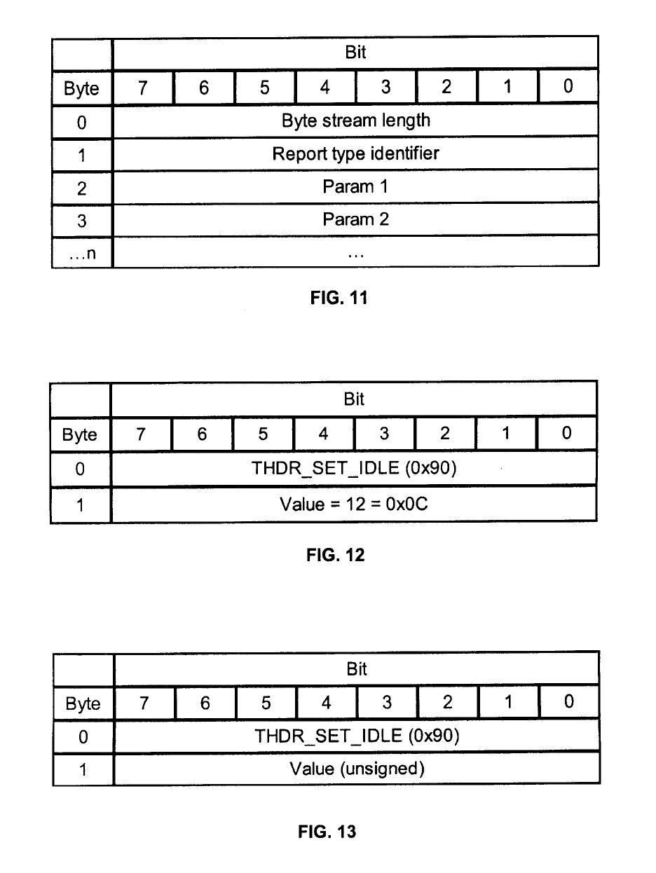

FIG. 11 illustrates an exemplary byte sequence for the bidirectional serial communication protocol 700, 1000. A predetermined structure for the byte sequence is parsed by drivers on both the controller device 1010 and host device 1020. The byte sequence is designed specifically to support variable length serialization of data. The byte sequence length is encoded as the first byte (byte 0). The information encoded in the byte 0 indicates the byte sequence length of the data packet. A report type identifier (e.g., similar to ones for HIDP) is encoded at byte 1. Parameters pertinent to the specific report type encoded in byte 1 are serialized from byte 2 to byte n, where n is the byte sequence length. Because byte 0 indicates the byte sequence length of the data packet to come, the bytes starting from byte 1 (e.g., 1 through n bytes) reflect the byte length and the pertinent data to be processed. The types and semantics of the parameters, the way the parameters are ordered, and the number of bytes that the parameters occupy may vary from one report type to another. When the parameters occupy more than one byte (e.g. a timestamp may require 4 bytes for full representation), the bytes may be serialized in a preferred network convention with the most significant byte (MSB) coming first (also known as the Big Endian convention). In an alternative implementation, the bytes may be serialized with the least significant byte (LSB) coming first (also known as the Little Endian convention).

Any data that is reasonably compact in footprint and serializable such that the binary format fits within a 255-byte envelope may be easily transferred using the bidirectional serial communication protocol as described in this specification. Larger packets of data may be serialized and discretized into a number of smaller consecutive packets, with each packet designed to fit within the 255-byte envelope. By dividing the larger data packets into discrete number of smaller packets, any serializable data stream can be transmitted using the bidirectional serial communication protocol.

A paired set of parsers/serializers can be provided on both the mobile controller device side 710, 1010 and the host device side 720, 1020 that understand how to interpret those reports. For best compatibility, the parsers and serializers for the bidirectional serial communication protocol are version-matched on both sides. However, any version of the parser on either the mobile controller device side 710, 1010 or the host device side 720, 1020 can be designed to be able to receive a new serial communication based on the byte length encoded in the first byte, and examine the second byte to determine whether the parser recognizes the report type identifier. Depending on whether the report type identifier is recognized, the parser may elect to act upon the report type identifier, or ignore the received serial report based on a detection of an unknown report type identifier.

The following paragraphs describe in detail an exemplary implementation of a bidirectional serial communication protocol for mobile controller devices to transfer data to and from host devices. The examples are provided for illustrative purposes only, and other specific implementations of the byte sequences are possible. In addition, the types of sensors supported and the types of data transferred are also examples only. Implementations can enable support for other sensor types and data types under the platform independent communication protocol 134 implemented under the bidirectional communication protocol mechanism described in this specification.

An SPP data stream on the host device 1020 is viewed as an uninterrupted stream of data. The bidirectional serial communication protocol as described in this specification is packet-oriented, where each message is encapsulated in a packet. Since the host device's SPP implementation hides the notion of a packet, an “envelope scheme” is provided. In particular, each message is preceded by a byte count. For example, when the host device 1020 wants to send a SET_IDLE message to the controller device 1010 with a value of 12, the SET_IDLE message is formatted as shown in FIG. 12. (See below for details on the SET_IDLE message.) The host device 1020 writes the following bytes to the data stream: 0x02 0x90 0x0C.

The first byte (0x02) represents the number of bytes (i.e., byte count) in the next message. The next two bytes, 0x90 (the SET_IDLE message header) and 0x0C (the SET_IDLE value) are interpreted to be the SET_IDLE message.

In some implementations, to maintain forward compatibility, unrecognized DATA packets (i.e., input and output reports) are ignored.

A one-byte Handshake message is sent as acknowledgement of any SET_IDLE or DATA_OUTPUT messages. A list of valid Handshake values includes the following:

| | |
|---|---|
| HANDSHAKE_SUCCESSFUL | 0x00 |
| HANDSHAKE_NOT_READY | 0x01 |
| HANDSHAKE_ERR_INVALID_REPORT_ID | 0x02 |
| HANDSHAKE_ERR_UNSUPPORTED_REQUEST | 0x03 |
| HANDSHAKE_ERR_INVALID_PARAMETER | 0x04 |
| HANDSHAKE_ERR_UNKNOWN | 0x0E |
| HANDSHAKE_ERR_FATAL | 0x0F |

By default, the controller device 1010 sends input (e.g., button) events whenever the button state changes (i.e., when a button is pressed or released). The controller device 1010 supports the sending of button repeat events at a fixed period. This fixed period is identified in the SET_IDLE message by setting the idle rate (i.e., the repeat rate) of the controller.

An idle rate of zero (0) is interpreted as having no button repeat events emitted. This is the default behavior of the controller device 110, 710, 1010 whenever a new connection is established. The host device 120, 720, 1020 can send a SET_IDLE message to the controller device 110, 710, 1010 to specify a new repeat rate. The repeat rate is set to be the value sent in the SET_IDLE message, multiplied by a set amount of time (e.g., 4 ms). For example, sending a SET_IDLE message with a value of 12 has the controller device 110, 710, 1010 emit button repeat events every 48 ms.

The SET_IDLE message is responded to by using various applicable values. For example, a response to a valid SET_IDLE message is a HANDSHAKE_SUCCESSFUL value of 0x00. Alternatively, when detected that the length of the SET_IDLE message is not 2 bytes long, then a HANDSHAKE_ERR_INVALID_PARAMETER value of 0x04 is sent as a response. Also, when detected that the specified idle rate is less than the latency of the connection (assumed to be 50 ms), the controller device 110, 710, 1010 sets the idle rate to be equal to the latency. FIG. 13 describes an exemplary data sequence showing the idle rate.

When a connection is established between a controller device 110, 710, 1010, various standard reports are sent to the host device 120, 720, 1020. The standard reports sent includes (1) a Version Report; (2) a Configuration Data Report showing the Button Count; (3) zero or more Button Metadata Reports; (4) zero or more Configuration Data Reports; and (5) a Configuration Data report with a type of 0xFF and a value of 0x00000000. In addition, other custom reports can be sent.

A standard report represents the input and output available to be used in an API. For example, “input” is considered to be data flowing from the controller device 110, 710, 1010 to the host device 120, 720, 1020. “Output” is considered to be data flowing from the host device 120, 720, 1020 to the controller device 110, 710, 1010. All multi-byte values are sent in network byte order (big Endian). All strings are sent in UTF-8 (8-bit UCS/Unicode Transformation Format). While this is a standard convention, multi-byte values and strings can also be sent in other byte orders and other string formats as well.

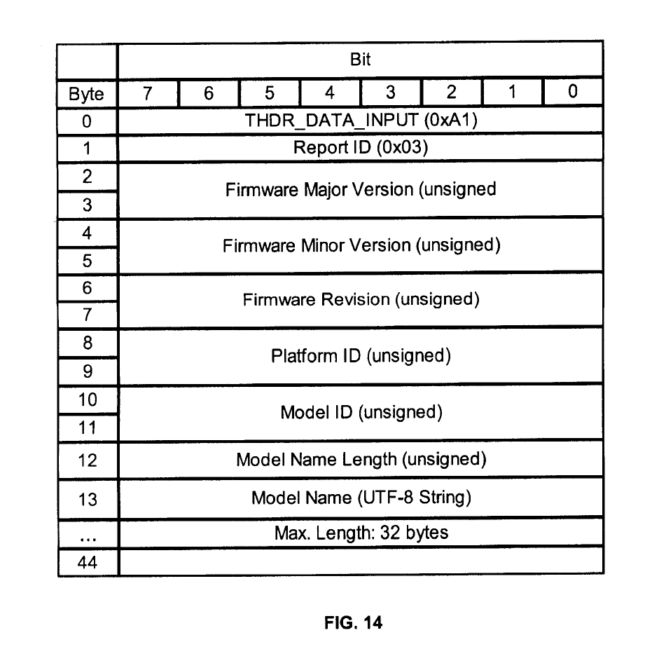

FIG. 14 illustrates an exemplary byte sequence for a Version Report. An input report ID of 0x03 is assigned to the Version Report. After a connection is established, the Version Report is the first packet sent. The Firmware Major Version (bytes 2-3) identifies the version of the bidirectional serial communication protocol. The Firmware Minor Version (bytes 4-5) is incremented whenever features are added to the firmware. The Firmware Revision (bytes 6-7) is incremented whenever new releases are performed (e.g., bug fixes). The Platform ID (bytes 8-9) identifies the current platform (i.e., hardware or processor) as shown in Table 1.

TABLE 1
Platform ID Values

0x0000: BlueCore4 PNG
0x0001: PIC
0x0002-0xFFFF: Reserved

### The Model ID Identifies the Controller Model's Layout

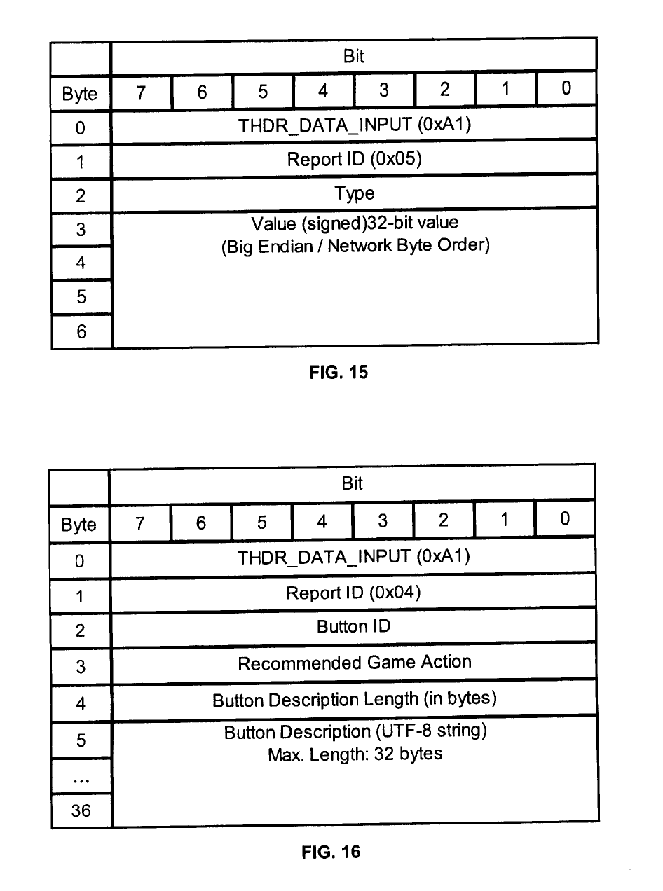

FIG. 15 illustrates an exemplary byte sequence for a Configuration Data Report Input Report. An input report ID (e.g., 0x05) is assigned to the Configuration Data report. After connecting and sending the Version Report, the controller device 110, 710, 1010 sends one or more Configuration Data reports to the host device 120, 720, 1020. The Type field (byte 2) specifies the controller configuration data sent in the Configuration Data report. A list of valid Type values are listed in Table 2.

TABLE 2
List of Type Values for Configuration Data Reports

0x01: Button Count
0x02: 2-Axis Joystick Count
0x03: 2-Axis Joystick Bits per Sample
0x04: 2-Axis Joystick Raw Center X Reading
0x05: 2-Axis Joystick Raw Center Y Reading
0x06: Trackball Count
0x07: Trackball Bits per Sample
0x08: Paddle Count
0x09: Paddle Bits per Sample
0x0A: Scroll Wheel Count
0x0B: Scroll Wheel Bits per Sample
0x0C: 3-Axis Accelerometer Count
0x0D: 3-Axis Accelerometer Bits per Sample
0x0E: Battery maximum voltage in mV (range: 0-65535)
0x0F: Battery minimum voltage in mV (range: 0-65535)
0x10: Battery warning voltage in mV (range: 0-65535)
0xFF: Configuration data complete (value = 0). This value is sent to notify
the host device 120, 220, 720, 920, 1120 that no more configuration data
will be sent.

The Value field (byte 3) contains the value corresponding to the type specified by the Type field (byte 2). Only those data that pertains to the controller device 110, 710, 1010 are be sent to the host device 120, 720, 1020. In other words, if the controller device 110, 710, 1010 has no accelerometers, no accelerometer count is sent.

The number of bits per sample, b, is greater than 2 and less than or equal to 32. The range of values allowed in the associated reports is represented as a range from (−2^{b-1}) to (2^{b-1}−1). For example, in one embodiment, the range of values for an 8-bit joystick can include −128 to 127 (representing a signed 8 bit value, with 0 being the middle of the range of motion). For a 12-bit joystick, the range of values includes −2048 to 2047. In some implementations, the range of values for an 8-bit joystick can range from 0 to 255 (representing an unsigned 8 bit value with 128 being the middle of the range of motion). For a 12-bit joystick, the range of values can include 0-4095, representing an unsigned 12-bit number, with 2048 being the middle of the range of motion.

Given the number of bits per sample for the various analog controls (e.g., joystick, accelerometer, paddle), the controller device 110, 710, 1010 emits input reports of the smallest size that fits that number of bits per sample. In other words, a 2-axis joystick with 10 bits per sample are sent in a 16-bit 2-axis joystick report.

FIG. 16 illustrates an exemplary byte sequence for a Button Metadata Report. An input report ID of 0x04 is assigned to the Button Metadata Report. After sending the configuration data reports, the controller device 110, 710, 1010 sends up to one Button Metadata report for each button on the controller. The Button Metadata Report includes a Button ID (byte 2) that is the same button ID that is reported in the Button Reports. The button description field is a human-readable depiction of the button (e.g., “Fire” or “Up”). The recommended game action field (byte-3) provides recommended semantics for each button. A list of values for the recommended game action field are provided in Table 3. The recommended game action values outside of this range are treated as undefined.

TABLE 3
List of Type Values for Recommended Game Action

0x00: Undefined
0x01: Up
0x02: Down
0x03: Left
0x04: Right
0x05: Fire
0x06: Game A
0x07: Game B
0x08: Game C
0x09: Game D

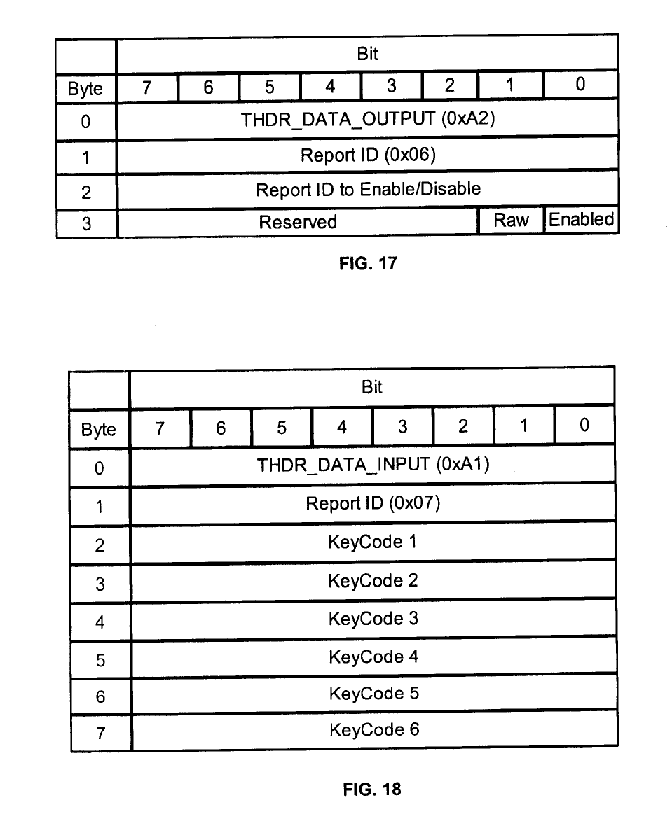

FIG. 17 illustrates an exemplary byte sequence for an Enable/Disable Report Type. An Output Report ID value of 0x06 is assigned (byte-1) to the Enable/Disable Report. Byte 2 of the Enable/Disable Report contains a Report ID that can be enabled or disabled. Any input report (flowing from a controller device to a host device) can be enabled or disabled. Bit 0 of Byte 3 is set to enabled or cleared to disable the specified Report ID.

Bit 1 of byte 3 in the Enable/Disable Report specifies whether the reports should be conditioned. When bit 1 of byte 3 is detected to be set, reports of the specified type are not conditioned. When the bit is detected to be cleared, reports of the specified type are optionally conditioned with a signal conditioning software algorithm on the controller device. Signal conditioning may involve implementation of a “dead zone” around the center of the joystick, truncation at the limits of the data range, scaling the raw data to generate resulting data in a given range, or other operations. When detected that the specified report ID is not an analog report, or is an analog report that does not use scaling, bit 1 of byte 3 is ignored (since no scaling can occur). When detected that specified Report ID cannot be enabled or disabled, or the specified Report ID is unrecognized, a HANDSHAKE_ERR_INVALID_PARAMETER is returned. Otherwise, a HANDSHAKE_SUCCESSFUL is returned.

FIG. 18 illustrates an exemplary byte sequence for a Button Report. An Input Report ID value of 0x07 is assigned (byte-1). The Button Report presents an array of key codes (bytes 2-7) representing the keys that are pressed. Any one or more of six keys (e.g., KeyCode 1-6) can be actuated at any given time. Key codes are assigned values sequentially from 0x00. These key codes reflect the button number. Buttons are numbered in order of precedence in the course of hardware design. The maximum key code value is 0xFD.

The key codes are listed in the report in increasing order. If the nth key is not pressed down, the key code for the non-actuated button is reported as KEYCODE_NO_EVENT (0xFE). When detected that more than six keys (buttons) are pressed down, all six key codes are reported as KEYCODE_ERROR_ROLL_OVER (0xFF).

When an idle rate is not specified, or when the idle rate is set to “0”, Button Reports are sent each time the button state changes. Alternatively, when detected that a non-zero idle rate is specified, Button Reports are sent repeatedly whenever one or more buttons are pressed down at the specified idle rate. SET_IDLE is described further below.

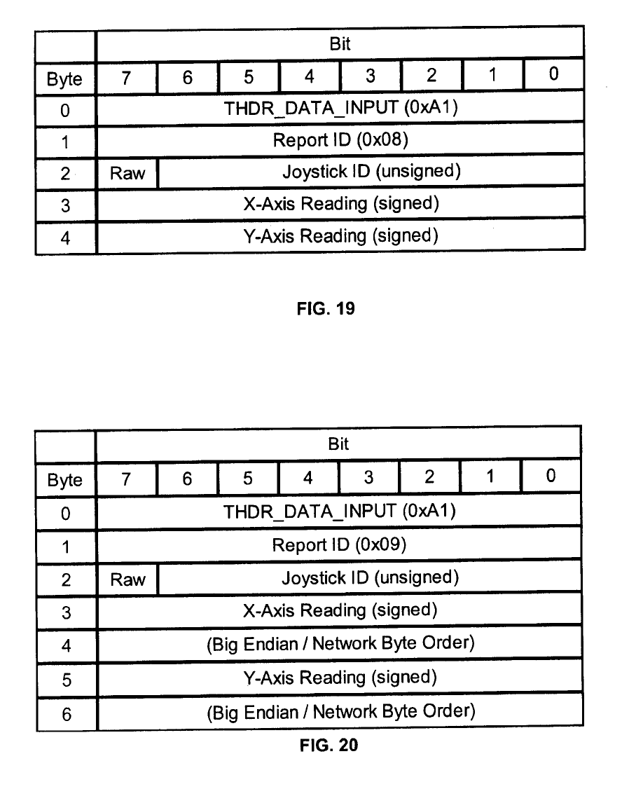

FIG. 19 illustrates an exemplary byte sequence for an 8-bit Analog 2-Axis Joystick Report. An Input Report ID value of 0x08 is assigned (byte 1). The Joystick ID (Byte-2) value is checked against the total number of joysticks reported by the configuration data (See Input Report (0x05)) and each new Joystick is numbered sequentially from 0 to n−1, where n equals the total number of joysticks present in the controller. Thus, for example, the first joystick is assigned a Joystick ID value of 0x00.

The center position is reported as (0, 0). The X-Axis reading increases as the joystick moves to the right. The Y-Axis reading increases as the joystick moves down. When detected that the raw bit (byte 2, bit 7) is set, the reading is not conditioned. Alternatively, when the raw bit is cleared, the reading is conditioned.

FIG. 20 illustrates an exemplary 16-bit Analog 2-Axis Joystick Report. An Input Report ID value of 0x09 is assigned (Byte 1). The Joystick ID value is less than the joystick count returned by the configuration data (Input Report (0x05)). Thus, the first joystick is assigned an ID value of 0x00.

While similarly designed as the 8-bit report, 16-bits are allocated for each Axis reading. The center position is reported as (0, 0). The X-Axis reading increases as the joystick moves to the right. The Y-Axis reading increases as the joystick moves down. When detected that the raw bit (byte 2, bit 7) is set, the reading is not conditioned. When detected that the raw bit is cleared, the reading is conditioned.

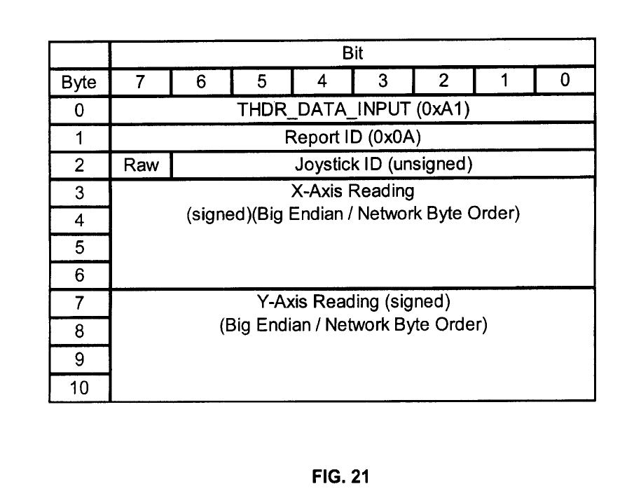

FIG. 21 illustrates an exemplary 32-bit Analog 2-Axis Joystick Report. An Input Report ID value of 0x0A is assigned (Byte 1). The Joystick ID value is less than the joystick count returned by the configuration data (Input Report (0x05)). Thus, the first joystick is assigned an ID value of 0x00.

While similarly designed as the 8-bit report, 32-bits are allocated for each Axis reading. The center position is reported as (0, 0). The X-Axis reading increases as the joystick moves to the right. The Y-Axis reading increases as the joystick moves down. When detected that the raw bit (byte 2, bit 7) is set, the reading is not conditioned. When detected that the raw bit is cleared, the reading is conditioned.

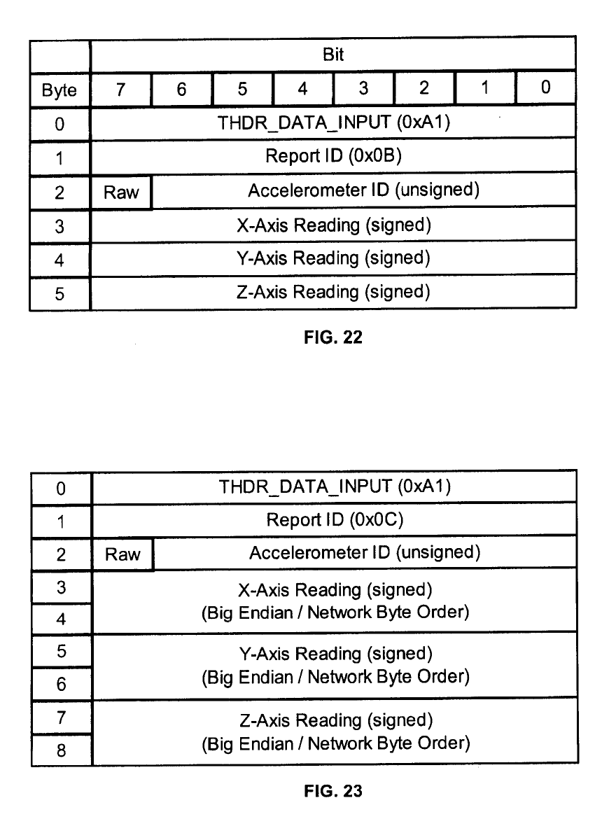

FIG. 22 illustrates an exemplary 8-bit Analog 3-Axis Accelerometer Report. An Input Report ID value of 0x0B is assigned (Byte 1). The Accelerometer ID value is less than the joystick count returned by the configuration data (Input Report (0x05)). Thus, the first accelerometer is assigned an ID value of 0x00. When detected that the raw bit (byte 2, bit 7) is set, the reading is not conditioned. When detected that the raw bit is cleared, the reading is conditioned.

FIG. 23 illustrates an exemplary 16-bit Analog 3-Axis Accelerometer Report. An Input Report ID value of 0x0C is assigned (Byte 1). The Accelerometer ID value is less than the joystick count returned by the configuration data (Input Report (0x05)). Thus, the first accelerometer is assigned an ID value of 0x00. When detected that the raw bit (byte 2, bit 7) is set, the reading is not conditioned. When detected that the raw bit is cleared, the reading is conditioned.

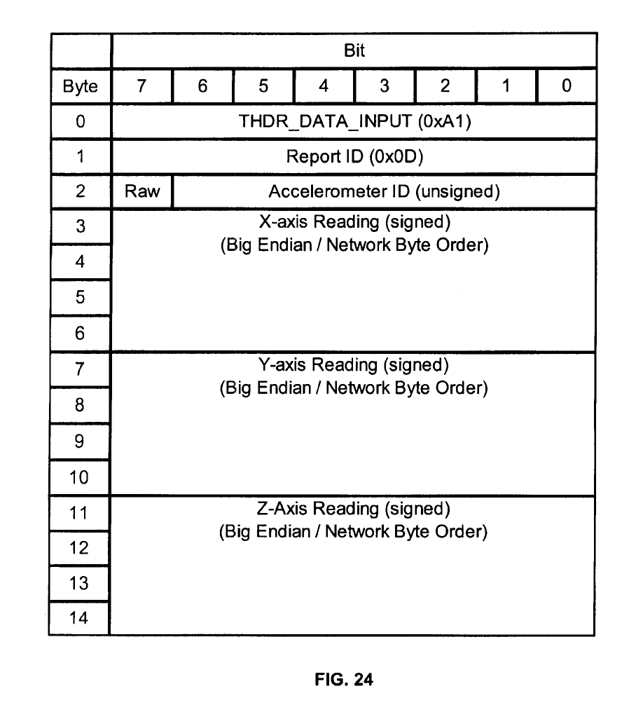

FIG. 24 illustrates an exemplary 32-bit Analog 3-Axis Accelerometer Report. An Input Report ID value of 0x0D is assigned (Byte 1). The Accelerometer ID value is less than the joystick count returned by the configuration data (Input Report (0x05)). Thus, the first accelerometer is assigned an ID value of 0x00. When detected that the raw bit (byte 2, bit 7) is set, the reading is not conditioned. When detected that the raw bit is cleared, the reading is conditioned.

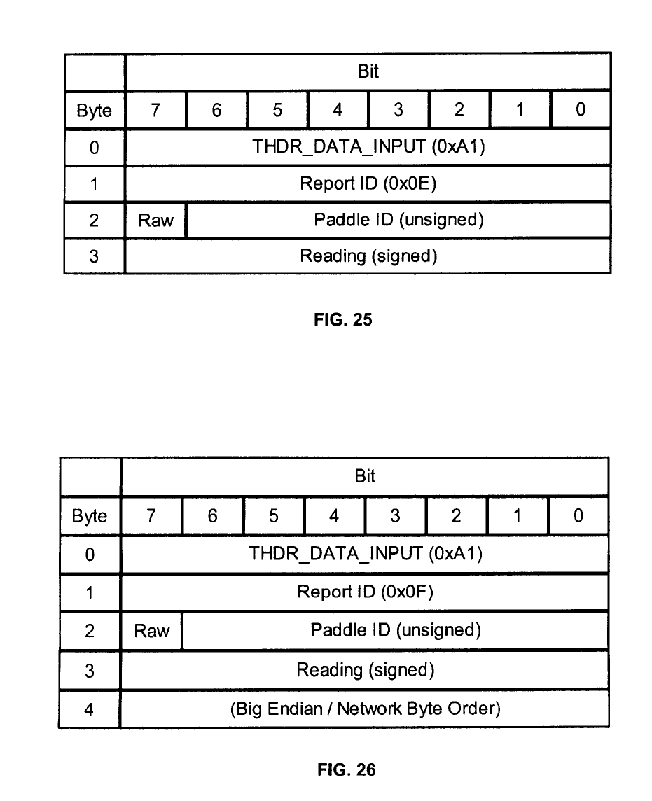

FIG. 25 illustrates an exemplary 8-bit Analog Paddle Report. In one embodiment, a paddle is implemented in hardware as a rotary potentiometer with a fixed range of motion. An Input Report ID value of 0x0E is assigned (Byte 1). The Paddle ID value is less than the paddle count returned by the configuration data (Input Report (0x05)). Thus, the first paddle is assigned an ID value of 0x00. The center position shall be reported as “0”. When detected that the raw bit (byte 2, bit 7) is set, the reading is not conditioned. When detected that the raw bit is cleared, the reading is conditioned.

FIG. 26 illustrates an exemplary 16-bit Analog Paddle Report. An Input Report ID value of 0x0F is assigned (Byte 1). The Paddle ID value is less than the paddle count returned by the configuration data (Input Report (0x05)). Thus, the first paddle is assigned an ID value of 0x00. The center position shall be reported as “0”. When detected that the raw bit (byte 2, bit 7) is set, the reading is not conditioned. When detected that the raw bit is cleared, the reading is conditioned. Sixteen-bits are assigned for each reading.

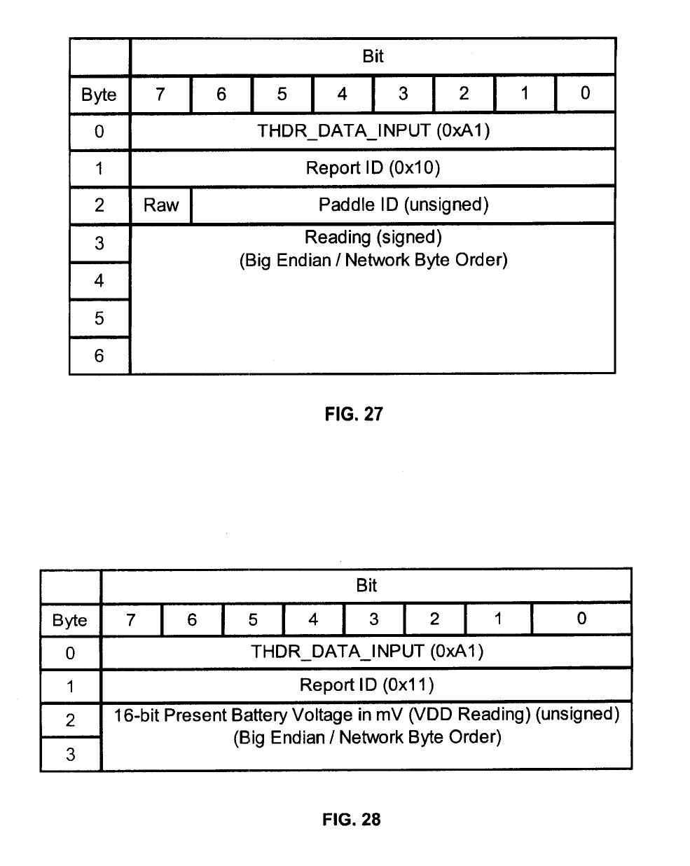

FIG. 27 illustrates an exemplary 32-bit Analog Paddle Report. An Input Report ID value of 0x10 is assigned (Byte 1). The Paddle ID value is less than the paddle count returned by the configuration data (Input Report (0x05)). Thus, the first paddle is assigned an ID value of 0x00. The center position shall be reported as “0”. When detected that the raw bit (byte 2, bit 7) is set, the reading is not conditioned. When detected that the raw bit is cleared, the reading is conditioned. Thirty two-bits are assigned for each reading.

FIG. 28 illustrates an exemplary 16-bit Battery Level Report. An Input Report ID value of 0x11 is assigned (Byte 1). The Battery Level Reports are sent at a fixed rate (e.g., once every 60 seconds.) Bytes 2-3 contain the current battery reading. Sixteen bits are assigned for the battery level reading.

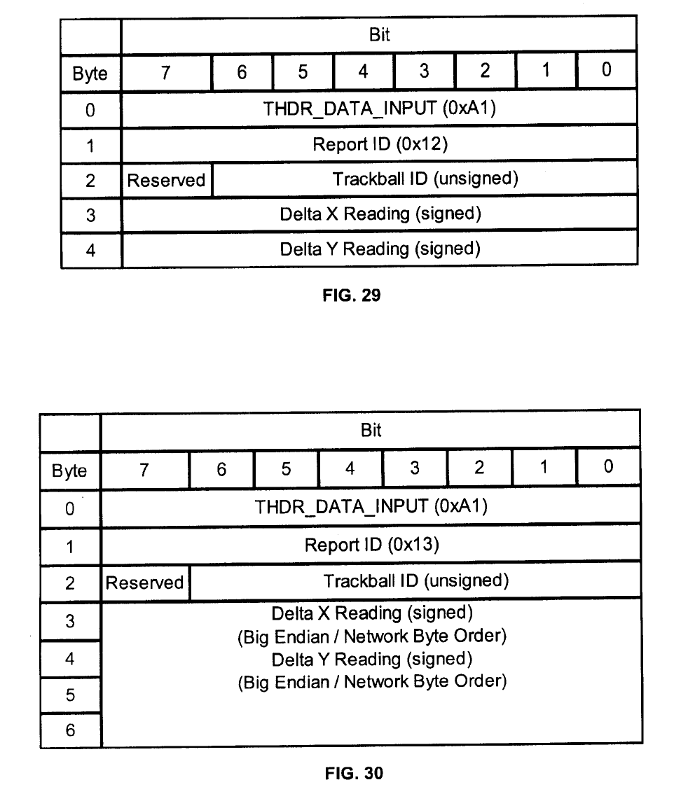

FIG. 29 illustrates an exemplary 8-bit Trackball Report. An Input Report ID value of 0x12 is assigned (Byte 1). The Trackball ID value is less than the trackball count returned by the configuration data (Input Report (0x05)). Thus, the first trackball is assigned an ID value of 0x00. The X reading is detected as a positive value as the trackball moves to the right. The Y reading is detected as a positive value as the trackball moves down. Eight bits are assigned for the X reading and the Y reading.

FIG. 30 illustrates an exemplary 16-bit Trackball Report. An Input Report ID value of 0x13 is assigned (Byte 1). The Trackball ID value is less than the trackball count returned by the configuration data (Input Report (0x05)). Thus, the first trackball is assigned an ID value of 0x00. The X reading is detected as a positive value as the trackball moves to the right. The Y reading is detected as a positive value as the trackball moves down. Sixteen bits are assigned for the X reading, and 16-bits are assigned for the Y reading.

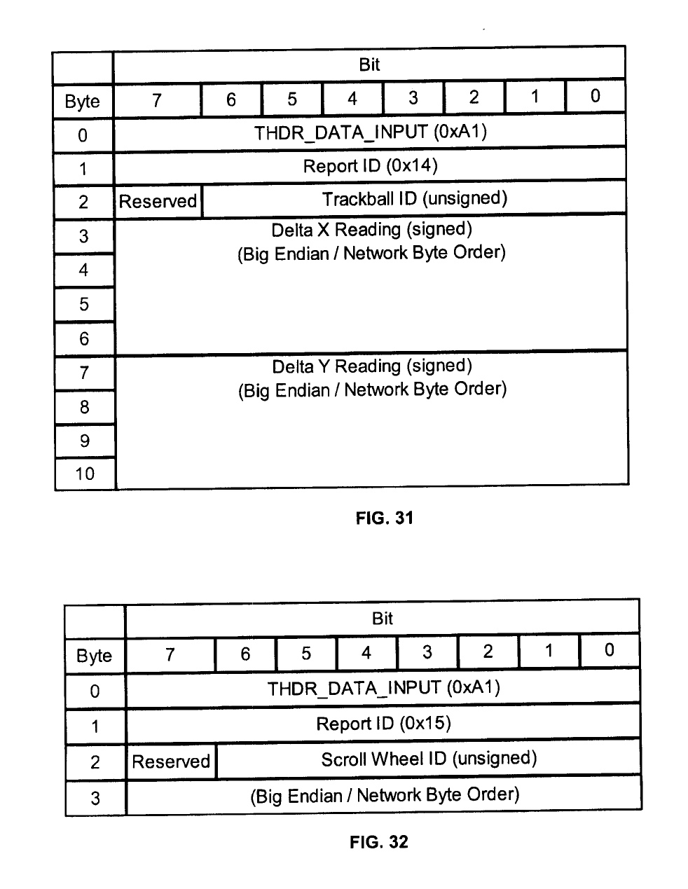

FIG. 31 illustrates an exemplary 32-bit Trackball Report. An Input Report ID value of 0x14 is assigned (Byte 1). The Trackball ID is less than the trackball count returned by the configuration data (Input Report (0x05)). Thus, the first trackball is assigned an ID value of 0x00. The X reading remains positive as the trackball moves to the right. The Y reading remains positive as the trackball moves down. Thirty two-bits are assigned for the X reading, and 32-bits are assigned for the Y reading.

FIG. 32 illustrates an exemplary 8-bit Scroll Wheel Report. An Input Report ID value of 0x15 is assigned (Byte 1). Input Report ID 0x15 The Scroll Wheel ID is less than the scroll wheel count returned by the configuration data (Input Report (0x05)). Thus, the first scroll wheel is assigned an ID value of 0x00. When the reading is positive, the scroll wheel is determined to have moved away or left. When the reading is negative, the scroll wheel is determined to have moved toward or right.

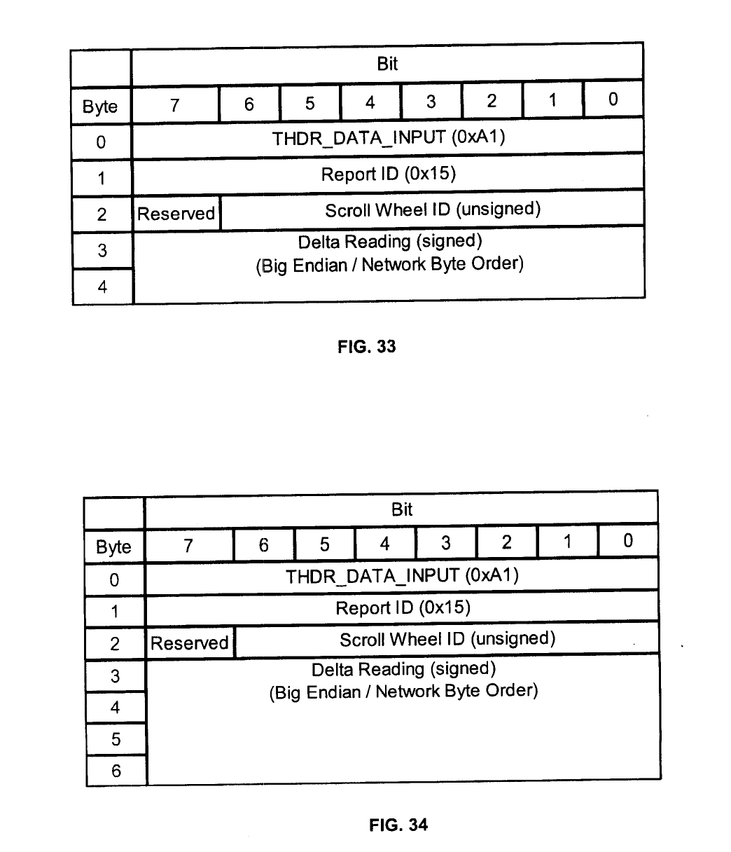

FIG. 33 illustrates an exemplary 16-bit Scroll Wheel Report. An Input Report ID value of 0x16 is assigned (Byte 1). The Scroll Wheel ID value is less than the scroll wheel count returned by the configuration data (Input Report (0x05)). Thus, the first scroll wheel is assigned an ID value of 0x00. When detected that the reading is positive, the scroll wheel is determined to have moved away or left. When the detected reading is negative, the scroll wheel is determined to have moved toward or right. Sixteen-bits are allocated for the reading.

FIG. 34 illustrates an exemplary 32-bit Scroll Wheel Report. An Input Report ID value of 0x17 is assigned (Byte 1). The Scroll Wheel ID value is less than the scroll wheel count returned by the configuration data (Input Report (0x05)). Thus, the first scroll wheel is assigned an ID value of 0x00. When the detected reading is positive, the scroll wheel is determined to have moved away or left. When the detected reading is negative, the scroll wheel is determined to have moved toward or right.

As described above, Analog reports can be delivered raw (not conditioned). In general, conditioned reports are designed to send signed readings centered at 0 and scaled to fill a predetermined range (as specified in the bits-per-sample configuration data report). Raw reports are reports with values that not been processed. The raw reports represent the unprocessed sensor readings. As such, the raw reports are unsigned and the center reading is specified by the configuration data report specified above. For example, when detected that a report is raw, the readings are unsigned. Alternatively, when a report is conditioned, the readings are signed.

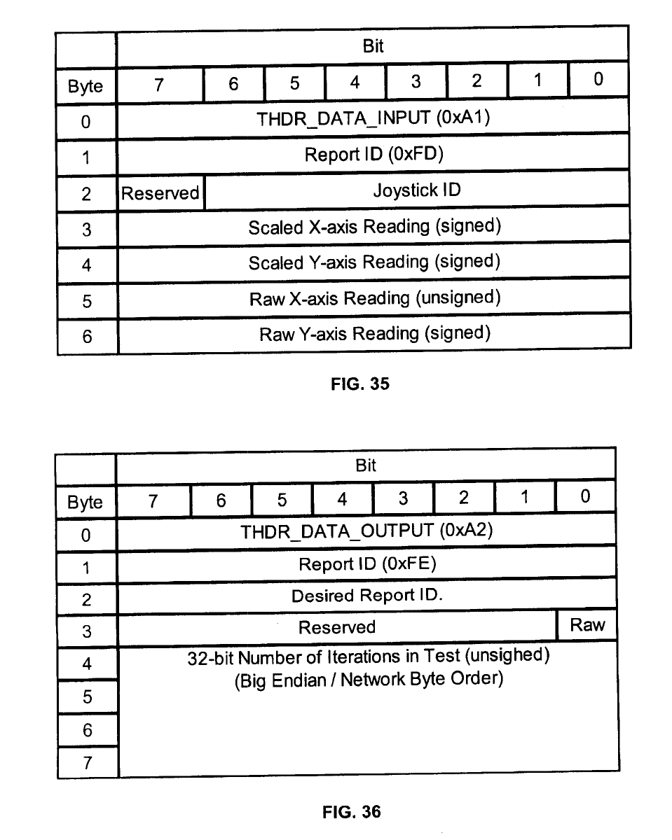

Various output reports can also be provided. FIG. 35 illustrates an exemplary byte sequence for a Raw and Conditioned 8-bit Analog 2-Axis Joystick Report. An Output Report ID value of 0xFD is assigned (Byte 1). The Raw and Conditioned 8-bit Analog 2-Axis Joystick Report is included for testing the performance of the scaling algorithm. The Raw and Conditioned 8-bit Analog 2-Axis Joystick Report is not intended for use outside of a testing application. The a Raw and Conditioned 8-bit Analog 2-Axis Joystick Report can be enabled using Output Report 0x06.

FIG. 36 illustrates an exemplary byte sequence for a Run Loop Test Report. An Output Report ID value of 0xFE is assigned. Upon receipt of a valid Run Loop Test report the controller device 110, 710, 1010 performs one or more of the following: (1) Reply to the host device 120, 720, 1020 with a HANDSHAKE_SUCCESSFUL; (2) Disable all currently enabled reports (including battery reports); (3) Send a timestamp report (Input Report ID 0XFF); (4) Send n reports where: (a) n is equal to the specified number of iterations (in bytes 4-7); (b) The report is of the specified type (in byte 2); (c) the report must be an analog report type; and (d) when the raw bit is set (bit 0 in byte 3), no scaling is done to the analog readings (alternatively, the usual scaling is performed when raw bit is cleared.); (5) Send a timestamp report (Input Report ID 0xFF); and (6) Re-enable the reports that were originally enabled.

Further, the Run Loop test report is valid when detected that the desired report ID (byte 2) is a report that is supported by the device. For example, when the controller device 110, 710, 1010 does not have an accelerometer, the desired report ID cannot specify an accelerometer report. Alternatively the Run Loop test report is valid when detected that the desired report ID specifies an analog report type.

Receipt of a Run Loop Test report with zero iterations specified (e.g., bytes 4-7 are all equal to 0x00) cancels any currently executing loop test. The control device responds with a HANDSHAKE_SUCCESSFUL, even if there is no test currently running.

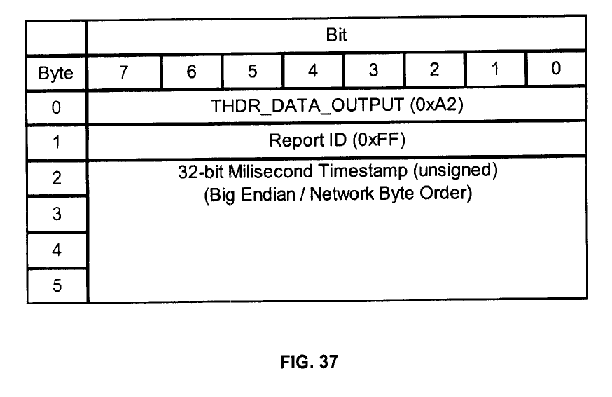

FIG. 37 illustrates an exemplary byte sequence for a 32-bit Device Timestamp (in Milliseconds) report. An Input Report ID value of 0xFF is assigned (Byte 1). The 32-bit Device Timestamp (in Milliseconds) report reflects the time on the control device 110, 710, 1010 as reported by its internal clock. The 32-bit Device Timestamp (in Milliseconds) report is only used in conjunction with a loop test.

Transferring Data Between a Mobile Controller Device and a Host Device

In one aspect, a platform independent communication protocol, as described in this specification, is designed to transfer control data (enable communications) from a human interface device (e.g., a controller device 1010) to a host device 1020. The platform independent communication protocol 134 provides support for various controller devices having various input mechanisms (e.g., joystick and button state) to transfer data to a host device running an application, such as a game, that can be controlled by the various controller devices. In addition, the platform independent communication protocol as described in this specification is extensible in that further reports can be added to support transport of other types of data. While the platform independent communication protocol may be described with respect to a Bluetooth Human Interface Profile (HID) or Bluetooth Serial Port Profile (SPP) connection, other baseband connections are equally applicable. The bidirectional serial communication protocol 1017, 1027 is independent of the connection type. However, using another transport protocol (e.g. L2CAP) may make the byte sequence length unnecessary, or impose other “overhead” in the transmission.

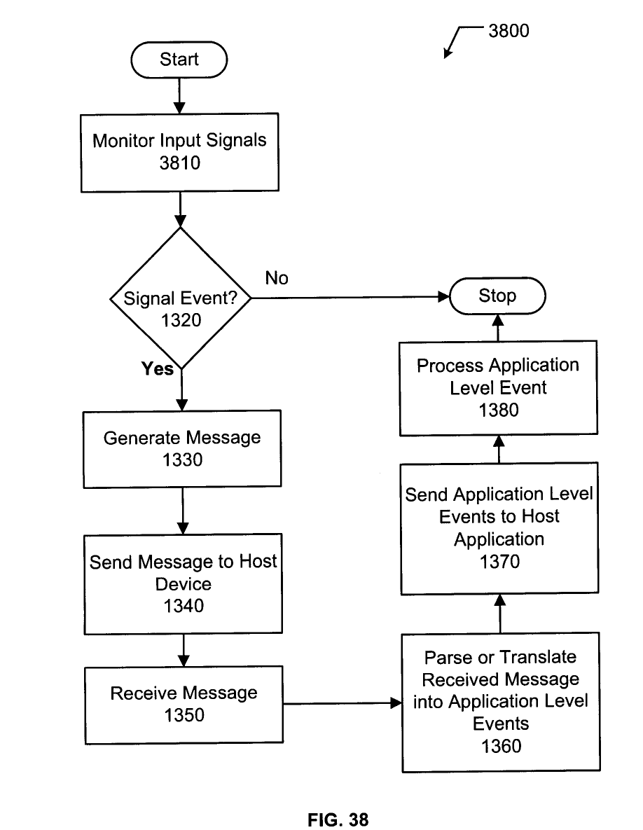

FIG. 38 is a process flow diagram illustrating process 3800 for enabling communications between a mobile controller device and a host device. Firmware on the controller device monitors 3810 input signals (e.g., analog and digital signals) provided by various input mechanisms available to the mobile controller device (e.g., buttons, joysticks, track balls, etc). Each input mechanism may include one or more input elements (e.g., buttons). Whenever a signal event occurs 3820 (e.g., a button is pressed, a joystick is moved), the controller firmware generates a message using the bidirectional serial communication protocol 1017 and sends the message to the host device 1020.

The message is generated 3830 by the controller firmware based on the detected signal event. The message consists of a number of bytes designed to support a wide variety of sensors, including those commonly used in gaming, such as analog signals from potentiometers, or multiple-degrees-of-freedom analog joysticks; digital encoders such as what might be found in optical mice, or in higher end robotic devices; force sensitive resistors which provide a proportional signal in response to varying pressures applied; accelerometer and gyroscope signals; signals from trackballs; signals from force sensing devices such as strain gauge based navigation sticks; proportional or digital signals from optical sensors; signals from electromagnetic sensors and the like. In the case of an HID based approach, the byte sequence is defined in a custom descriptor. In the case of a fixed-length serial approach, the best match is found between the signals from the sensors and the preset byte syntax. In the case of a bidirectional serial communication protocol, the byte sequence is variable and perfectly matched to the actual output of the sensors and/or any other data output from the mobile controller device.

At least one of the sequences of bytes are mapped to one or more input elements on the input mechanisms available to the mobile control device. For example, when the mobile controller device includes a keypad, at least one of the bytes can be mapped to one or more of the buttons on the keypad. Similarly, for a joystick, at least one of the bytes can be mapped to the various movements of the joystick and/or buttons on the joystick. Additionally, each sensor type may be represented by a distinct report type identifier so that a variety of sensors may be supported by the same firmware and host software.

The generated message is sent 3840 to the host device. The controller driver running on the host device and linked to the host application, receives 3850 the message and translates 3860 the message into one or more application level events. These translated events are then sent 3870 to the host application. The host application processes 3880 the translated events. For example, when the host application is a game, the translated events are processed to execute a game function corresponding to a button press, joystick movement, etc.

Bluetooth Implementation

To establish a connection between a controller device and a host device, a controller device 1010 waits for another device to take initiative to connect. A host device 1020 (e.g., a cell phone, a PC, a mobile device, etc.) takes initiative to form a connection to the controller device 1010. The controller device 1010 provides an SPP Server (or L2CAP server, etc.) for the host device 1020 to connect. That Server can be identified, via the Service Discovery Profile (SDP), using a universally unique identifier (UUID). In one embodiment, this UUID can be selected to be associated with the platform independent communication protocol. All future implementations of the platform independent communication protocol can use the same UUID to provide backwards-compatibility. When a different UUID is used, backwards-compatibility is not guaranteed. A host device 1020 looking to connect to a controller device can identify the UUID. In an alternative embodiment, the UUID may be changed to reflect upgrades to the platform independent communication protocol.

Example Applications

The data transferred across the platform independent communication protocol may or may not be directly related to sensor output. For example, timestamp data may be retrieved. In another example, the mobile controller device may be used as a data transfer and storage device for other platforms.

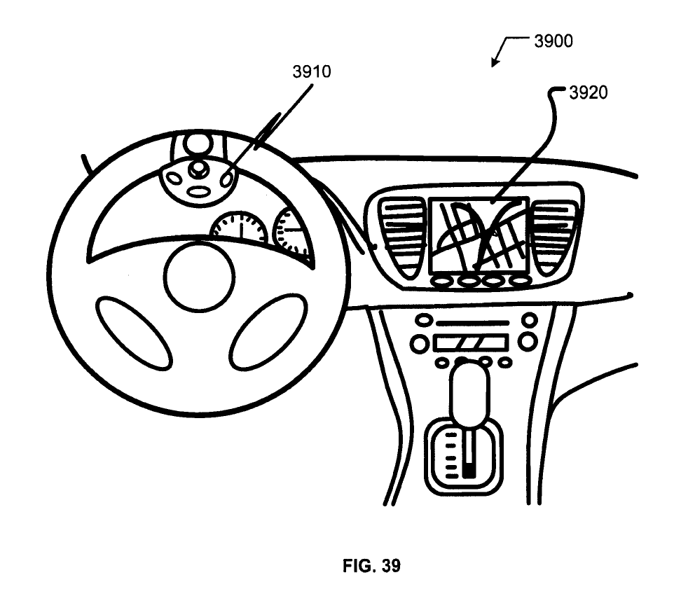

FIGS. 39-44 outline a few more examples where the platform independent communication protocol may be applied. FIG. 39 illustrates an exemplary system 3900 for implementing a Java enabled remote controller device 3910 that controls mapping application on a navigation system 3920. For example, a remote controller device 3910 can be used to control a mapping application on a car navigation system 3920 mounted on the dashboard of the car, or integrated into the center console. The remote controller device 3910 can be held in the hand, clamped to the car steering wheel, etc. The baseband connection in this example can be Bluetooth, if supported by the navigation system, or a wired connection such as USB. Using the controller device 3910, addresses and points of interest can be entered into the navigation system 3920 using the unique designs on the remote controller. The platform independent communication protocol as described in this specification enables such information to be efficiently encoded and transported to the navigation system 3920 without taking up a great deal of memory footprint either on the controller side or on the navigation system side.

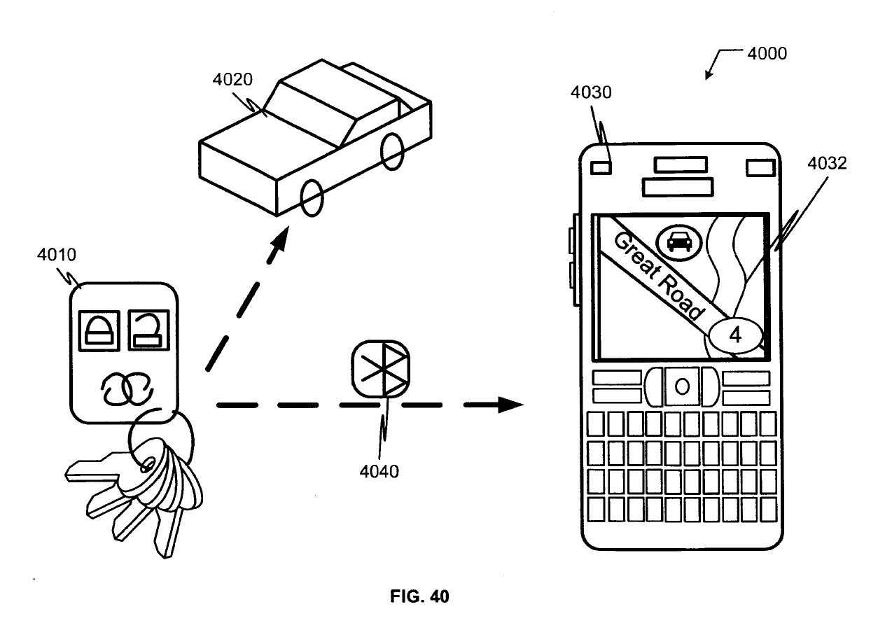

FIG. 40 illustrates an exemplary system 4000 for providing data exchange between GPS enabled devices. For example, a GPS enabled car 4020, a remote controller device 4010 and a mapping application 4032 running on a mobile phone device 4030 can communicate with one other via the platform independent communication protocol described in this specification. The platform independent communication protocol can be implemented over Bluetooth 4040 to allow the GPS enabled car 4020 to communicate with the mobile phone 4030. The specific information sent from the car 4020 to the mobile phone can include data describing the GPS location of the car 4020 at the time the ignition was shut off. For example, the platform independent communication protocol as described in this specification can be implemented to enable communications in a co-pending patent application entitled “System and Method for Providing Local Maps Using Wireless Handheld Devices” (U.S. patent application Ser. No. 11/620,604). The contents of this copending application (U.S. patent application Ser. No. 11/620,604) is incorporated by reference.

FIG. 41 illustrates an exemplary system 4100 for enabling data communications among a mobile phone 4110, car 4120 and a PC 4130. For example, a Bluetooth equipped car 4120 can communicate data (e.g., car's mechanical state information) to a mobile phone 4110 via the platform independent communication protocol. The mobile phone 4110 can then be used to upload the data to a Bluetooth enabled PC 4130 using the platform independent communication protocol described in this specification. Information such as the mileage, wear and tear on the car, etc. can be tracked on the PC to enable timely preventative maintenance and repairs before failures occur on the car.

In a similar example (not shown), the controller may retrieve GPS information from a navigation device, whether portable or integrated into a vehicle, and store it for future upload to a PC for review.

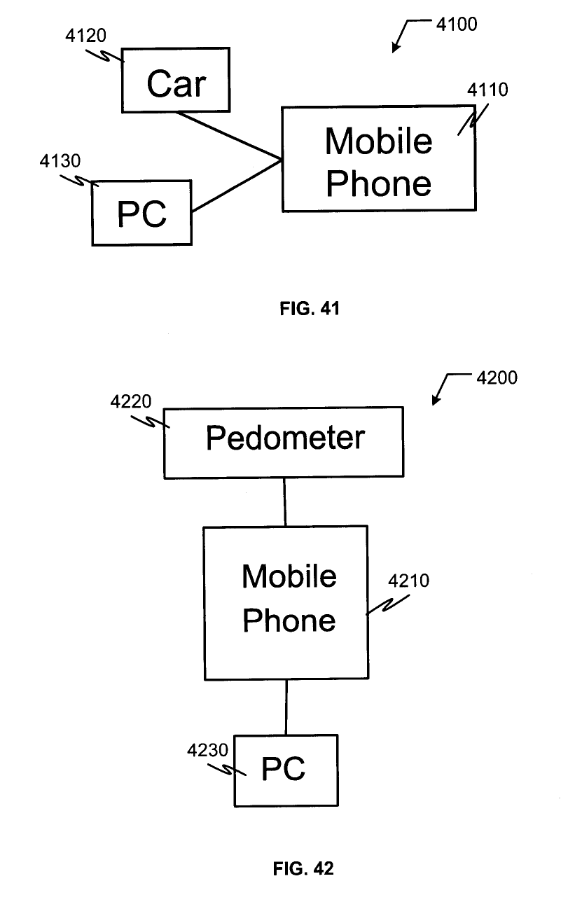

FIG. 42 illustrates an exemplary system 4200 for enabling data communications among multiple health and fitness devices. For example, a mobile phone 4210 can be linked to a pedometer 4220 using the platform independent communication protocol described in this specification. Data from the pedometer 4220 can be serialized. As a person exercises, the pedometer can stream the serialized pedometer data to the mobile phone 4210, which can then keep track of the exercise status of the person with the pedometer. The data received on the mobile phone 4210 can be transported to a PC using the same platform independent communication protocol described in this specification.

FIG. 43 illustrates an exemplary system 4300 for enabling data communications between a Java-enabled joystick controller 4310 and mobile phone 4320. For example, a remote controller 4310 with an analog joystick, can communicate with a mobile phone 4320 over the platform independent communication protocol described in this specification. The mobile phone 4320 may be running games on the J2ME platform, for example. The games support the platform independent communication protocol, and thus the games can make use of a software library that encodes analog joystick signals, other switch signals, or any other data transferred over Bluetooth from the controller device 4310 to the phone 4320. For example, the platform independent communication protocol as described in this specification can be implemented to enable communications in a co-pending patent applications entitled “Human Input Acceleration System” (U.S. patent application Ser. No. 11/519,455).

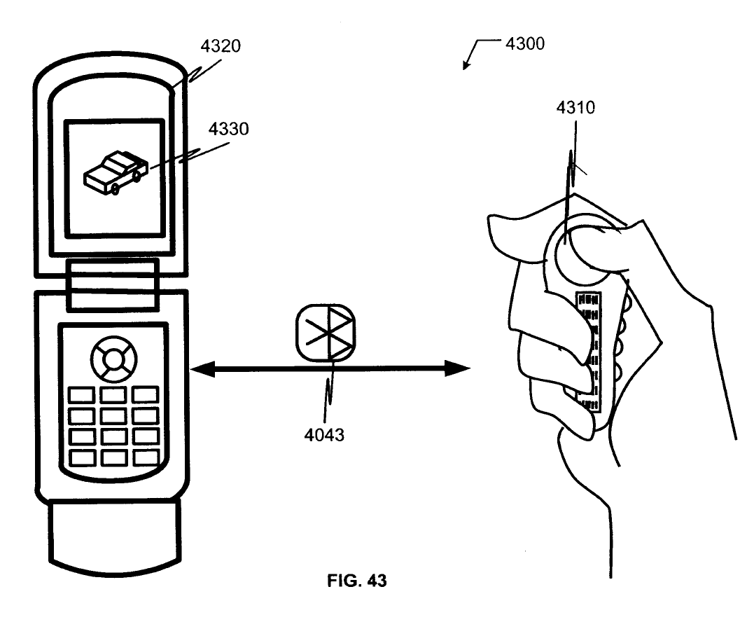

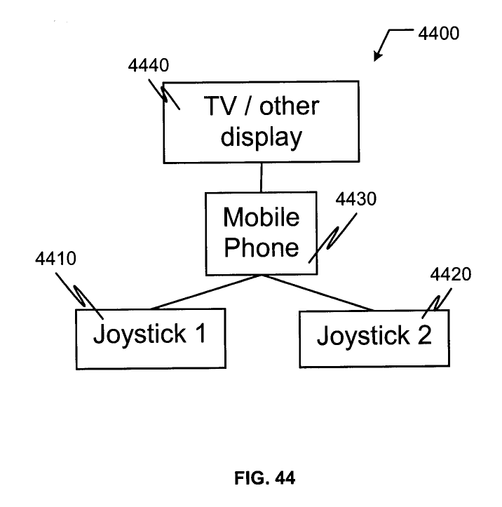

FIG. 44 illustrates an exemplary system 4400 for enabling communications in a multi-player mobile gaming scenario. For example, two players can play a game on a mobile phone 4430 together. Each player has his own controller 4410, 4420. The mobile phone 4430 supports gaming on the J2ME platform, and supports video output to a TV or other display devices 4440. The mobile phone 4430 communicates with both controllers 4410, 4420 simultaneously via the platform independent communication protocol as described in this specification. The two gainers can enjoy a game console-like experience while playing a game that is running on the mobile phone 4430.

In another example (not shown), the controller device may retrieve game state information from a host device (e.g. a mobile phone), and transfer the information to a PC either for backup, or for platform independent game play for games which are also supported on the PC. Conversely, the controller device may retrieve game state information from a PC and transfer it to a mobile phone. Other platforms may be supported as well. The mobile controller device may therefore become a vehicle by which the gaming experience may be carried from one platform across another. For example, the platform independent communication protocol as described in this specification can be implemented to enable communications in a co-pending patent application entitled “Universal Controller for Toy and Games” (U.S. patent application Ser. No. 11/519,455).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this application.

Moreover, the methods to provide data input, device control or game control may be performed in a different order and still achieve desirable results. Accordingly, other implementations are within the scope of the following claims.

What is claimed is:

1. A method comprising:
providing platform independent bidirectional communications between a mobile controller device and a host device over a communication protocol, wherein providing includes
delivering an array of bytes from the mobile controller device to the host device, wherein the array of bytes describes one or more data packets of the mobile controller device;
when detected that the host device includes a native device driver, using the native device driver to parse the delivered array of bytes; and
when detected that the host device does not include a native device driver, providing a device driver to parse the delivered array of bytes.

2. The method of claim 1, wherein providing the device driver comprises providing a customized human interface device driver based on the delivered array of bytes.

3. The method of claim 1, wherein providing the platform independent bidirectional communications comprises providing bidirectional communications compatible with Java platform.

4. The method of claim 1, wherein delivering the array of bytes comprises using a fixed number of bytes from the array of bytes to generate one or more device specific descriptors that support one or more sensors not supported by a native human interface device descriptor.

5. The method of claim 4, wherein generating the one or more device specific descriptors that support one or more sensors comprises generating one or more device specific descriptors that support at least one selected from a group of a joystick, a linear potentiometer, a trackball, an encoder, a force sensitive resistor, a strain gauge, a series of digital switches, an accelerometer, a gyro, an inertial sensor, and an electromagnetic sensor.

6. The method of claim 1, wherein providing the platform independent bidirectional communications comprises providing at least two communication channels that are accessible by a Java platform driver.

7. The method of claim 1, wherein delivering an array of bytes comprises delivering a variable sequence of bytes customized for the mobile controller device.

8. The method of claim 7, wherein delivering a variable sequence of bytes comprises:
mapping each byte in the sequence of bytes to one or more input elements on the mobile controller device; and
changing a value assigned to each byte based on a state of the input element.

9. A computer program product, embodied on a computer-readable medium, operable to cause a data processing apparatus to perform operations comprising:
providing platform independent bidirectional communications between a mobile controller device and a host device over a communication protocol, wherein providing includes
delivering an array of bytes from the mobile controller device to the host device, wherein the array of bytes describes one or more data packets of the mobile controller device;
when detected that the host device includes a native device driver, using the native device driver to parse the delivered array of bytes; and
when detected that the host device does not include a native device driver, providing a device driver to parse the delivered array of bytes.

10. The computer program product of claim 9, operable to cause the data processing apparatus to perform operations further comprising providing a customized human interface device driver based on the delivered array of bytes.

11. The computer program product of claim 9, operable to cause the data processing apparatus to perform operations further comprising providing platform independent bidirectional communications by at least providing bidirectional communications compatible with Java platform.

12. The computer program product of claim 9, operable to cause the data processing apparatus to perform operations further comprising delivering an array of bytes by at least using a fixed number of bytes from the array of bytes to generate one or more device specific descriptors that support one or more sensors not supported by a native human interface device descriptor.

13. The computer program product of claim 12, operable to cause the data processing apparatus to perform operations further comprising generating one or more device specific descriptors that support one or more sensors by at least generating one or more device specific descriptors that support at least one selected from a group of a joystick, a linear potentiometer, a trackball, an encoder, a force sensitive resistor, a strain gauge, a series of digital switches, an accelerometer, a gyro, an inertial sensor, and an electromagnetic sensor.

14. The computer program product of claim 9, operable to cause the data processing apparatus to perform operations further comprising providing platform independent bidirectional communication having at least two communication channels that are accessible by a Java platform driver.

15. The computer program product of claim 9, further operable to cause the data processing apparatus to perform operations further comprising delivering an array of bytes having a variable sequence of bytes customized for the mobile controller device.

16. The computer program product of claim 15, further operable to cause the data processing apparatus to perform operations further comprising delivering a variable sequence of bytes comprising:
mapping each byte in the sequence of bytes to one or more input elements on the mobile controller device; and
changing a value assigned to each byte based on a state of the input element.

17. A mobile controller device comprising:
a communication mechanism configured to operate a communication stack including
a baseband protocol configured to connect the mobile controller device to a host device,
a bidirectional serial communication protocol configured to operate over the baseband protocol to send one or more messages to the host device, wherein each message comprises a sequence of bytes; and
a controller firmware configured to
monitor input signals provided by various input mechanisms available to the mobile controller device, and
generate the one or more messages;
wherein the bidirectional serial communication protocol enables platform independent bidirectional communications between the mobile controller device and a host device over the baseband protocol.

18. The system of claim 17, wherein the bidirectional serial communication protocol enables platform independent bidirectional communications comprising a bidirectional communication compatible with Java platform.

19. The system of claim 17, wherein the controller firmware is further configured to take a fixed number of bytes from the sequence of bytes to generate one or more device specific descriptors that support one or more sensors not supported by a native human interface device descriptor.

20. The system of claim 19, wherein the controller firmware is further configured to generate one or more device specific descriptors that support at least one selected from a group of a joystick, a linear potentiometer, a trackball, an encoder, a force sensitive resistor, a strain gauge, a series of digital switches, an accelerometer, a gyro, an inertial sensor, and an electromagnetic sensor.

21. The system of claim 17, wherein the controller firmware is further configured to generate the one or more messages, each generated message comprising a variable sequence of bytes customized for the mobile controller device.

22. The system of claim 22, wherein the controller firmware is further configured to map each byte in the sequence of bytes to one or more input elements of the various input mechanisms available to the mobile controller device and change a value assigned to each byte based on a state of the mapped one or more input elements.
